(19) United States
(12) Patent Application Publication
(10) Pub. No.: US 2026/0197132 A1
(43) Pub. Date: Jul. 9, 2026

(54) APPARATUS AND METHOD FOR DMRS SIGNALING

(71) Applicant: Nokia Technologies Oy, Espoo (FI)

(72) Inventors: Pavan KOTESHWAR SRINATH, Orsay (FR); Sivarama VENKATESAN, West Orange, NJ (US)

(73) Assignee: Nokia Technologies Oy, Espoo (FI)

(21) Appl. No.: 19/134,422

(22) PCT Filed: Dec. 19, 2022
(86) PCT No.: PCT/EP2022/086542

§ 371 Date: May 30, 2025

(51) Int. Cl. H04L 5/00

(52) U.S. Cl. CPC H04L 5/0048

(57) ABSTRACT

Certain examples of the present disclosure relate to an apparatus (10, 120) comprising: means (11, 15) for sending, to one or more User Equipment, UE (110), demodulation reference signal, DMRS, matrix information (401) indicative of a row-orthogonal DMRS matrix (P); means (11, 15) for sending, to a UE (UEi) of the one or more UE, DMRS submatrix information (402) indicative of a submatrix (Pi) of the row-orthogonal DMRS matrix that has been assigned to the UE; means (11, 15) for receiving, from the UE, said at least one DMRS determined by the UE based, at least in part, on the DMRS matrix information and the DMRS submatrix information.

### TECHNOLOGICAL FIELD

Examples of the present disclosure relate to an apparatus and method for demodulation reference signal, DMRS, signaling. Some examples, though without prejudice to the foregoing, relate to an apparatus and method for uplink dedicated DMRS signaling in next generation extreme Multi-User Multiple-Input Multiple-Output, MU-MIMO, systems.

### BACKGROUND

A significant increase in uplink traffic is anticipated in the next generation (i.e. 6G) of Radio Access Network, RAN, because there are a number of industrial and consumer applications (for example video surveillance and video sharing) that need more uplink bandwidth. To meet this demand, multiple User Equipments, UEs, will need to be co-scheduled for transmission on the uplink, UL, so that they share the same Resource Elements, REs. Each UE itself might have multiple spatial streams, or spatial layers, of data to transmit simultaneously on the same RE.

Dedicated demodulation reference symbols, DMRS, are used for channel estimation (i.e. to estimate channels between UEs and a gNB) and for demodulation of physical channels. Current 5G standards allow only up to a maximum of 12 orthogonal DMRSs per slot (namely, for DMRS Type 2, Double symbol DMRS, there can be up to 12 DMRS ports). This restricts the total number of separable spatial layers from co-scheduled UEs (i.e. UEs that are co-scheduled to use the same uplink transmission slot) to 12 spatial layers. There is a proposed extension to current 5G standards (i.e. in 3GPP Release 18) to allow up to a maximum of 24 orthogonal DMRSs per slot (namely, for DMRS Type 2, Double symbol DMRS, there could be up to 24 DMRS ports). This would restrict the total number of separable spatial layers from co-scheduled UEs to 24 spatial layers.

In some circumstances it can be desirable to provide an improved apparatus and method for DMRS signaling. In some circumstances it can be desirable to provide a signaling scheme for supporting an efficient and scalable DMRS pattern, and which can support greater amounts of uplink traffic (e.g. more than 24 spatial layers on the uplink).

The listing or discussion of any prior-published document or any background in this specification should not necessarily be taken as an acknowledgement that the document or background is part of the state of the art or is common general knowledge. One or more aspects/examples of the present disclosure may or may not address one or more of the background issues.

### BRIEF SUMMARY

The scope of protection sought for various embodiments of the invention is set out by the claims.

According to various, but not necessarily all, examples of the disclosure there are provided examples as claimed in the appended claims. Any examples and features described in this specification that do not fall under the scope of the independent claims are to be interpreted as examples useful for understanding various embodiments of the invention.

According to at least some examples of the disclosure there is provided an apparatus comprising:
means for sending, to one or more User Equipment, UE, demodulation reference signal, DMRS, matrix information indicative of a row-orthogonal DMRS matrix;
means for sending, to a UE of the one or more UE, DMRS submatrix information indicative of a submatrix of the row-orthogonal DMRS matrix that has been assigned to the UE;
means for receiving, from the UE, said at least one DMRS determined by the UE based, at least in part, on the DMRS matrix information and the DMRS submatrix information.

According to various, but not necessarily all, examples of the disclosure there is provided a method comprising:
sending, to one or more User Equipment, UE, demodulation reference signal, DMRS, matrix information indicative of a row-orthogonal DMRS matrix;
sending, to a UE of the one or more UE, DMRS submatrix information indicative of a submatrix of the row-orthogonal DMRS matrix that has been assigned to the UE;
receiving, from the UE, said at least one DMRS determined by the UE based, at least in part, on the DMRS matrix information and the DMRS submatrix information.

According to various, but not necessarily all, examples of the disclosure there is provided a computer program comprising instructions, which when executed by an apparatus, cause the apparatus to perform:
sending, to one or more User Equipment, UE, demodulation reference signal, DMRS, matrix information indicative of a row-orthogonal DMRS matrix;
sending, to a UE of the one or more UE, DMRS submatrix information indicative of a submatrix of the row-orthogonal DMRS matrix that has been assigned to the UE;
receiving, from the UE, said at least one DMRS determined by the UE based, at least in part, on the DMRS matrix information and the DMRS submatrix information.

According to various, but not necessarily all, examples of the disclosure there is provided an apparatus comprising:
at least one processor; and
at least one memory storing instructions that, when executed by the at least one processor, cause the apparatus at least to:
send, to one or more User Equipment, UE, demodulation reference signal, DMRS, matrix information indicative of a row-orthogonal DMRS matrix;
send, to a UE of the one or more UE, DMRS submatrix information indicative of a submatrix of the row-orthogonal DMRS matrix that has been assigned to the UE;
receive, from the UE, said at least one DMRS determined by the UE based, at least in part, on the DMRS matrix information and the DMRS submatrix information.

According to various, but not necessarily all, examples of the disclosure there is provided a non-transitory computer readable medium encoded with instructions that, when executed by at least one processor, causes at least the following to be perform:
sending, to one or more User Equipment, UE, demodulation reference signal, DMRS, matrix information indicative of a row-orthogonal DMRS matrix;
sending, to a UE of the one or more UE, DMRS submatrix information indicative of a submatrix of the row-orthogonal DMRS matrix that has been assigned to the UE;
receiving, from the UE, said at least one DMRS determined by the UE based, at least in part, on the DMRS matrix information and the DMRS submatrix information.

According to at least some examples of the disclosure there is provided a User Equipment, UE, comprising:
means for receiving, from a Radio Access Network, RAN, node, demodulation reference signal, DMRS, matrix information indicative of a row-orthogonal DMRS matrix;
means for receiving, from the RAN node, DMRS submatrix information indicative of a submatrix of the row-orthogonal DMRS matrix that has been assigned to the UE;
means for determining at least one DMRS based at least in part on the DMRS matrix information and the DMRS submatrix information;
means for transmitting, to the RAN node, the at least one DMRS.

According to various, but not necessarily all, examples of the disclosure there is provided a method comprising:
receiving, at a User Equipment, UE, from a Radio Access Network, RAN, node, demodulation reference signal, DMRS, matrix information indicative of a row-orthogonal DMRS matrix;
receiving, at the UE from the RAN node, DMRS submatrix information indicative of a submatrix of the row-orthogonal DMRS matrix that has been assigned to the UE;
determining, at the UE, at least one DMRS based at least in part on the DMRS matrix information and the DMRS submatrix information;
transmitting, from the UE to the RAN node, the at least one DMRS.

According to various, but not necessarily all, examples of the disclosure there is provided a computer program comprising instructions, which when executed by a User Equipment, UE, cause the UE to perform:
receiving, from a Radio Access Network, RAN, node, demodulation reference signal, DMRS, matrix information indicative of a row-orthogonal DMRS matrix;
receiving, from the RAN node, DMRS submatrix information indicative of a submatrix of the row-orthogonal DMRS matrix that has been assigned to the UE;
determining at least one DMRS based at least in part on the DMRS matrix information and the DMRS submatrix information;
transmitting the at least one DMRS.

According to various, but not necessarily all, examples of the disclosure there is provided a User Equipment, UE, comprising:
at least one processor; and
at least one memory storing instructions that, when executed by the at least one processor, cause the apparatus at least to:
   receive, from a Radio Access Network, RAN, node, demodulation reference signal, DMRS, matrix information indicative of a row-orthogonal DMRS matrix;
   receive, from the RAN node, DMRS submatrix information indicative of a submatrix of the row-orthogonal DMRS matrix that has been assigned to the UE;
   determine at least one DMRS based at least in part on the DMRS matrix information and the DMRS submatrix information;
   transmit the at least one DMRS.

According to various, but not necessarily all, examples of the disclosure there is provided a non-transitory computer readable medium encoded with instructions that, when executed by at least one processor, causes at least the following to be perform:
receiving, at a User Equipment, UE, from a Radio Access Network, RAN, node, demodulation reference signal, DMRS, matrix information indicative of a row-orthogonal DMRS matrix;
receiving, at the UE from the RAN node, DMRS submatrix information indicative of a submatrix of the row-orthogonal DMRS matrix that has been assigned to the UE;
determining, at the UE, at least one DMRS based at least in part on the DMRS matrix information and the DMRS submatrix information;
transmitting, from the UE to the RAN node, the at least one DMRS.

According to various, but not necessarily all, examples of the disclosure there is provided a chipset comprising processing circuitry configured to perform a method as described herein.

According to various, but not necessarily all, examples of the disclosure there is provided a module, circuitry, device and/or system comprising means for performing a method as described herein.

The following portion of this ‘Brief Summary’ section describes various features that can be features of any of the examples described in the foregoing portion of the ‘Brief Summary’ section. The description of a function should additionally be considered to also disclose any means suitable for performing that function.

In some but not necessarily all examples, the DMRS matrix information comprises DMRS matrix type information indicative of a type of the row-orthogonal DMRS matrix.

In some but not necessarily all examples, the DMRS matrix information comprises DMRS matrix size information indicative of a first dimension and/or a second dimension of the row-orthogonal DMRS matrix.

In some but not necessarily all examples, the apparatus further comprises means for determining a size of the row-orthogonal DMRS matrix, wherein the size of the row-orthogonal DMRS matrix is based, at least in part, on one or more selected from the group of:
a number of orthogonal DMRSs to be generated by the one or more UE, and
a number of transmitting spatial layers to be supported.

In some but not necessarily all examples, the apparatus further comprises means for determining one or more selected from the group of:
a number of orthogonal DMRSs to be generated by the one or more UE, and
a number of transmitting spatial layers to be supported.

In some but not necessarily all examples, the size of the row-orthogonal DMRS matrix is greater than or equal to the total number of transmitting spatial layers of the one or more UE.

In some but not necessarily all examples, the apparatus further comprises means for assigning the submatrix of the row-orthogonal DMRS matrix to the UE.

In some but not necessarily all examples, the information indicative of the submatrix of the row-orthogonal DMRS matrix comprises at least one selected from the group of:
information indicative of one or more identifiers of one or more rows of the row-orthogonal DMRS matrix assigned to the UE;
information indicative of a rank of the UE; and
information indicative of a number of transmitting layers assigned to the UE.

In some but not necessarily all examples, each element of the row-orthogonal DMRS matrix has a unit magnitude.

In some but not necessarily all examples, the one or more UE comprises a plurality of UE that are co-scheduled on an uplink transmission slot.

In some but not necessarily all examples, the apparatus further comprises:
means for sending, to a plurality of co-schedule UE, DMRS matrix information indicative of a row-orthogonal DMRS matrix;
means for sending, to each UE, DMRS submatrix information indicative of a submatrix of the row-orthogonal DMRS matrix that has been assigned to the respective UE; means for sending DMRS resource allocation information indicative of a plurality of resources allocated to the transmission of the plurality of UE's respective one or more DMRSs;
means for sending configuration information for configuring each UE to transmit its respective one or more DMRSs over the of plurality of allocated resources such that each UE transmits its respective one or more DMRSs over the same plurality of allocated resources;
means for receiving, over the same plurality of allocated resources, each UE's respective one or more DMRSs.

In some but not necessarily all examples, the UE further comprises means for receiving, from the RAN node, information indicative of resources allocated to the transmission of the at least one DMRS.

In some but not necessarily all examples, the UE further comprises means for generating a base DMRS matrix for the UE, based at least in part on the DMRS matrix information and the DMRS submatrix information, wherein the base DMRS matrix for the UE is defined as a submatrix of the row-orthogonal DMRS matrix that corresponds to the submatrix of the row-orthogonal DMRS matrix assigned to the UE indicated in the DMRS submatrix information.

In some but not necessarily all examples, the UE further comprises means for receiving, from the RAN node, information indicative of a value unique to a Radio Access Node; and means for generating, based at least in part on the value, a pseudo-random diagonal matrix.

In some but not necessarily all examples, the UE further comprises means for generating a DMRS matrix for the UE based, at least in part, on the base DMRS matrix for the UE and the pseudo-random diagonal matrix.

In some but not necessarily all examples, the UE further comprises means for generating a UE DMRS transmission matrix for controlling the UE's transmission of the one or more DMRSs, wherein the UE DMRS transmission matrix is generated based, at least in part, on applying the DMRS matrix for the UE to a precoder and/or a power scalar.

In some but not necessarily all examples, the UE further comprises means for controlling the transmission of the one or more DMRSs based at least in part on the UE DMRS transmission matrix.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION OF THE DRAWINGS

Some examples will now be described with reference to the accompanying drawings in which:

FIG. 1 shows an example of the subject matter described herein;

FIG. 2 shows another example of the subject matter described herein;

FIG. 3 shows another example of the subject matter described herein;

FIG. 4 shows another example of the subject matter described herein;

FIG. 5 shows another example of the subject matter described herein;

FIG. 6 shows another example of the subject matter described herein;

FIG. 7 shows another example of the subject matter described herein;

FIG. 8 shows another example of the subject matter described herein;

FIG. 9 shows another example of the subject matter described herein;

FIG. 10 shows another example of the subject matter described herein;

FIG. 11 shows another example of the subject matter described herein;

FIG. 12 shows another example of the subject matter described herein;

FIG. 13 shows another example of the subject matter described herein; and

FIG. 14 shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the drawings (and description) a similar feature may be referenced by the same three-digit number. In the drawings (and description), an optional subscript to the three-digit number can be used to differentiate different instances of similar features. Therefore, a three-digit number without a subscript can be used as a generic reference and the three-digit number with a subscript can be used as a specific reference. A subscript can comprise a single digit that labels different instances. A subscript can comprise two digits including a first digit that labels a group of instances and a second digit that labels different instances in the group.

### Abbreviations/Definitions

DCI Downlink Control Information
DFT Discrete Fourier Transform
DMRS (Dedicated) Demodulation Reference Signal
gNB Next generation NodeB
HARQ Hybrid automatic repeat request
I+N Interference-plus-Noise
IRC Interference-Rejection and Combining
LMMSE Linear Minimum Mean Square Error
MCMLLS Multi-Cell, Multi-Link-Level simulation
MU-IRC Multi-User IRC
MU-MIMO Multi-User Multiple-Input Multiple-Output
OCC Orthogonal Cover Code
OFDM Orthogonal Frequency Division Multiplexing
PAPR Peak-to-Average-Power Ratio
PRB Physical Resource Block
RAN Radio Access Network
RE Resource Element
SINR Signal-to-Interference Noise Ratio
SNR Signal-to-Noise Ratio
TRX Transceiver
UE User Equipment
UL Uplink

### DETAILED DESCRIPTION

The figures schematically illustrate, and the following description describes, various examples of the disclosure including an apparatus (10, 120) comprising:
means (11, 15) for sending, to one or more User Equipment, UE (110), demodulation reference signal, DMRS, matrix information (401) indicative of a row-orthogonal DMRS matrix (P) for the one or more UE to use for the purpose of determining one or more DMRSs (404) for the one or more UE to transmit;
means (11, 15) for sending, to a UE (UEᵢ) of the one or more UE, DMRS submatrix information (402) indicative of a submatrix (Pⁱ) of the row-orthogonal DMRS matrix that has been assigned to the UE for the purpose of determining at least one DMRS for the UE to transmit; and
means (11, 15) for receiving, from the UE, said at least one DMRS determined by the UE based, at least in part, on the DMRS matrix information and the DMRS submatrix information.

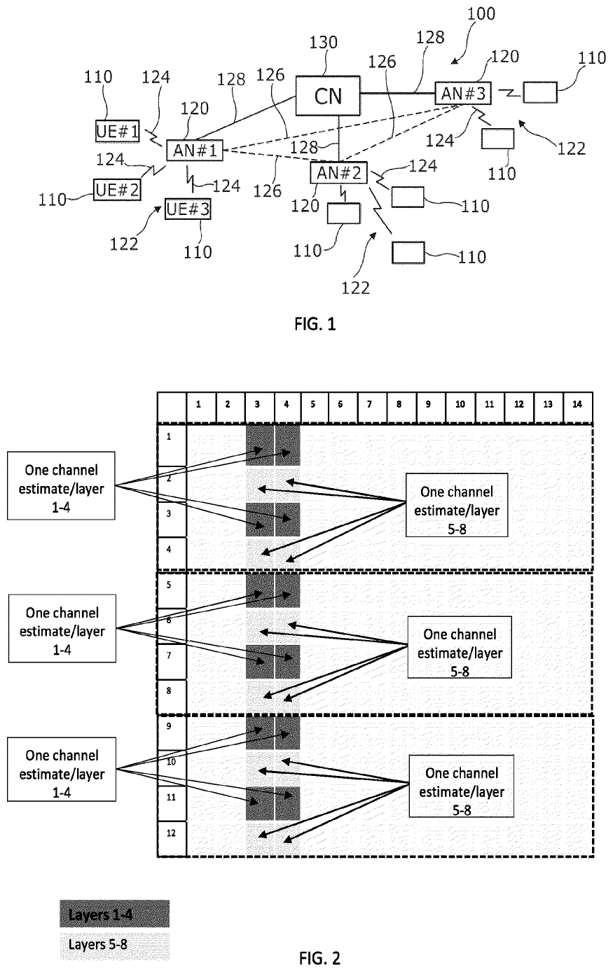

FIG. 1 schematically illustrates an example of a network 100 suitable for use with examples of the present disclosure. The network comprises a plurality of network nodes including terminal nodes 110 (also referred to as User Equipment, UE), access nodes 120 (also referred to as Transmission Reception Points, TRPs; or Radio Access Nodes, RANs), one or more core nodes 130. The terminal nodes 110 and access nodes 120 communicate with each other. The one or more core nodes 130 may, in some but not necessarily all examples, communicate with each other. The one or more access nodes 120 may, in some but not necessarily all examples, communicate with each other.

The network 100 is in this example a radio telecommunications network, i.e., a Radio Access Network, RAN, in which at least some of the terminal nodes 110 and access nodes 120 communicate with each other using transmission/reception of radio waves.

The RAN 100 may be a cellular network comprising a plurality of cells 122 each served by an access node 120. The access nodes 120 comprise cellular radio transceivers. The terminal nodes 110 comprise cellular radio transceivers.

In the particular example illustrated, the network 100 may be a Next Generation, NG, i.e. sixth generation, 6G, Radio Network that is currently under development (i.e. an evolution of the New Radio, NR, network of the Third Generation Partnership Project, 3GPP, and its fifth generation, 5G, technology).

The interfaces between the terminal nodes 110 and the access nodes 120 are radio interfaces 124 (e.g., Uu interfaces). The interfaces between the access nodes 120 and one or more core nodes 130 are backhaul interfaces 128 (e.g., S1 and/or NG interfaces).

Depending on the exact deployment scenario, the access nodes 120 can be RAN nodes such as NG-RAN nodes. NG-RAN nodes may be gNodeBs, gNBs, that provide NG user plane and control plane protocol terminations towards the UE. The gNBs connected by means of NG interfaces to a 6G Core (6GC), more specifically to an Access and Mobility Management Function, AMF, by means of an NG Control Plane, NG-C, interface and to a User Plane Function, UPF, by means of an NG User Plane, NG-U, interface. The access nodes 120 may be interconnected with each other by means of Xn interfaces 126.

The cellular network 100 could be configured to operate in licensed frequency bands, or unlicensed frequency bands (not least such as: unlicensed bands that rely upon a transmitting device to sense the radio resources/medium before commencing transmission, such as via a Listen Before Talk, LBT, procedure; and a 60 GHz unlicensed band where beamforming may be required in order to achieve required coverage).

The access nodes 120 can be deployed in an NG standalone operation/scenario. The access nodes 120 can be deployed in a NG non-standalone operation/scenario. The access nodes can be deployed in a Carrier Aggregation operation/scenario. The access nodes 120 can be deployed in a dual connectivity operation/scenario, i.e., Multi Radio Access Technology-Dual Connection, MR-DC.

In such non-standalone/dual connectivity deployments, the access nodes 120 may be interconnected to each other by means of X2 or Xn interfaces, and connected to an Evolved Packet Core, EPC, by means of an S1 interface or to the 5GC by means of a NG interface. The terminal nodes 110 are network elements in the network that terminate the user side of the radio link. They are devices allowing access to network services. The terminal nodes 110 may be referred to as User Equipment, UE, mobile terminals or mobile stations. The term ‘User Equipment’ may be used to designate mobile equipment comprising a smart card for authentication/encryption etc such as a Subscriber Identity Module, SIM. In other examples, the term ‘User Equipment’ is used to designate a location/position tag, a hyper/smart tag or a mobile equipment comprising circuitry embedded as part of the user equipment for authentication/encryption such as software SIM.

The access nodes 120 are network elements in the network responsible for radio transmission and reception in one or more cells 122 to or from the terminal nodes 110. Such access nodes may also be referred to as a Transmission Reception Points, TRPs, or base stations. The access nodes 120 are the network termination of a radio link. An access node 120 can be implemented as a single network equipment, or have a split architecture that is disaggregated/distributed over two or more RAN nodes, such as a Central Unit, CU, a Distributed Unit, DU, a Remote Radio Head-end, RRH, using different functional-split architectures and different interfaces.

Where the access node 120 has a disaggregated (split) architecture, the access node 120 can comprise one or more distributed units, gNB-DU, and a centralized unit, gNB-CU,—not shown in FIG. 1. The gNB-CU is a logical node configured to host a Radio Resource Connection, RRC, layer and other layers of the access node 120. The gNB-CU controls the operation of one or more gNB-DUs. The gNB-DU is a logical node configured to host Radio Link Control, RLC, protocol layer, Medium Access Control, MAC, layer and Physical, PHY, layer of the access node 120. The gNB-DU may communicate via a dedicated interface (e.g. an F1 interface) to an RRC layer hosted by the gNB-CU. One gNB-DU can support one or multiple cells 122, whereas one cell is supported by only one gNB-DU 220.

In the following description, an access node 120 will be referred to as a gNB 120 (or receiver) and a terminal node 110 will be referred to as a UE 110 (or transmitter).

FIG. 2 schematically illustrates a conventional DMRS patten. This figure shows DMRS REs in an Orthogonal Frequency Division Multiplexing, OFDM, Physical Resource Block, PRB, for a slot (12 subcarriers, 14 symbols) for a Type 1 double-symbol DMRS pattern.

This pattern supports up to 8 orthogonal DMRSs. Such orthogonality is achieved via: time, frequency and code (namely, for Type 1 double DMRS: 2 (time)×2 (frequency)×2 (code); i.e. DMRS symbols can be placed in one of two positions in the frequency domain, DMRS symbols can be placed in one of two positions in the time domain, and 2 the use of differing DMRS codes enables two different orthogonal DMRSs per RE).

The 8 orthogonal DMRSs enables up to 8 separable spatial layers/streams. However, not all the layers transmit on all the DMRS REs/locations (i.e. the layers do not all simultaneously transmit on the same time and frequency DMRS resources/at the same temporal and frequency DMRS locations). Accordingly, an interference pattern from other cells (e.g. neighbouring gNBs) would be different on these DMRS locations (assuming that the cells are time-synchronized and also use the same OFDM symbols for DMRS) than an interference pattern at the data REs (where all the layers transmit).

As indicated in FIG. 2, for each of layers 1-8, 3 channel estimates can be performed in the slot.

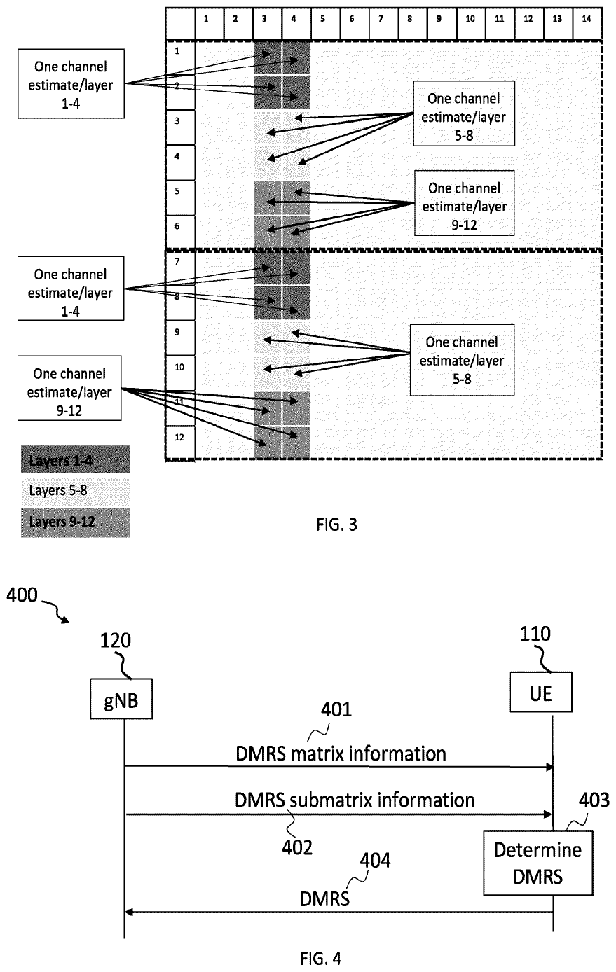

FIG. 3 schematically illustrates another conventional DMRS patten. This figure shows DMRS REs in an OFDM PRB for a slot for a Type 2 double-symbol DMRS pattern, which can support up to 12 orthogonal DMRS. Hence the overall upper limit on the number of separable spatial layers/streams is 12. However, for each of layers 1-12, only 2 channel estimates can be performed in the slot.

Similar to that as discussed with regards to the DMRS scheme of FIG. 2, in the DMRS scheme of FIG. 3, not all the layers transmit on all the DMRS REs (i.e. the layers do not all simultaneously transmit on the same time and frequency DMRS resources/at the same temporal and frequency DMRS locations). Accordingly, an interference pattern from other cells would be different on these DMRS locations than an interference pattern at the data REs (where all the layers transmit).

In 3GPP Release 18, it is proposed to increase the number of orthogonal DMRSs to 24 using a Type-2 pattern (and increase the number of orthogonal DMRSs to 16 using a Type-1 pattern). The principles underlying this are similar to that shown in FIGS. 1-2, the difference is that the length of the Orthogonal Cover Code, OCC, in frequency is increased to 4 from 2.

In each uplink transmission slot (e.g. as per FIG. 2 or 3), a channel of each UE can be estimated using DMRS. In order to be able to separate the channels concerned with each transmitted layer (from all the UEs), it is necessary that a DMRS assigned to each layer is orthogonal (in time or frequency or code or a combination of these) to every other layer's DMRS. A loss of orthogonality can potentially result in a severely degraded channel estimate, and this can have adverse effects on the resulting UE throughput.

It is expected that the uplink traffic will significantly increase in the future and, with each cell co-scheduling several UEs on the uplink, interference noise from out-of-cell transmissions is expected to dominate thermal noise. Since extreme MIMO (e.g. antenna arrays with more than 512 antenna elements) is expected to be a crucial aspect of future wireless systems, it is expected that this interference noise will be significantly coloured. Therefore, an interference-plus-noise, I+N, covariance needs to be estimated accurately (in a large dimensional receiver signal space) at each gNB in order to perform efficient symbol detection. In this regard:
an I+N covariance can be estimated at a gNB using a channel estimate and a DMRS at a DMRS REs, and
this I+N covariance can be subsequently used for noise-whitening and symbol detection at the data REs.

In order to perform the above operations accurately, it is necessary that the interference pattern on the DMRS locations (i.e. the DMRS RE's) is similar to the interference pattern at the data locations.

Issues/limitations with current/proposed 3GPP standards and conventional DMRS patterns/schemes include:
1) An ability to support only up to 24 orthogonal DMRS assignments to layers, i.e., 24 is an upper limit on the number of separable spatially multiplexed layers on the uplink.
2) An interference pattern at DMRS locations in a slot is different from that at data locations in a slot because not all the layers transmit on the same DMRS REs. This means that when a large antenna array is used at a gNB and an I+N is significantly coloured, its estimation at DMRS locations can lead to significantly mismatched Interference-Rejection and Combining, IRC, for data symbols at the gNB.
3) Inefficient DMRS usage—the current DMRS assignment is not efficient when handling a large number of co-scheduled UE. For example, if UEs A, B, and C are co-scheduled with their respective rank/number of spatial layers (or streams) being 3, 2, and 3, the current DMRS assignment scheme cannot incorporate these using the DMRS Type 1 pattern (with 8 orthogonal DMRS) even though the total number of spatial layers is 8. In this example, A and C have a rank equal to 3 (rank equals the number of spatial layers/streams) while B has rank equal to 2. As per the current standards (Table 6.4.1.1.3-1 of TS38.211), Code Division Multiplex, CDM, group 0 is for DMRS ports {0,1,4,5} and CDM group 1 is for DMRS ports {2,3,6,7}. For a rank 3 DMRS assignment, (Table 7.3.1.1.2-14 of TS38.212), only ports {0,1,4} and {2,3,6} can be assigned to a UE. So, if A is assigned DMRS ports {0,1,4} and C is assigned {2,3,6}, then, there is no possibility for a rank 2 assignment of ports {5,7} to B (Table 7.3.1.1.2-13 of TS38.212) since DMRS port 5 and port 7 belong to different CDM groups. This means that with Type 1 DMRS assignment, B cannot be accommodated for co-scheduling with A and C. Note that a port is identified with a predefined DMRS code (Table 6.4.1.1.3-1 of TS38.211) such that that the DMRS from one port is orthogonal to the DMRS from every other port. In this example, 8 ports are needed to transmit orthogonal DMRS for 8 spatial layers. So, one needs to use DMRS Type 2 in this case which supports up to 12 orthogonal DMRS, but this comes at the cost of reduced channel estimation accuracy. This is because Type 2 DMRS allows only 2 channel estimates to be obtained per layer in each PRB while Type 1 DMRS allows 3 channel estimates to be obtained (see FIGS. 2 and 3). Therefore, in this example, even though there are only 8 spatial layers for which DMRS Type 1 would have provided good channel estimation accuracy, one would have to employ DMRS Type 2 with reduced channel estimation accuracy as compared with using DMRS Type 1. In this case, inefficiency occurs due to having to utilize the lower accuracy Type 2 DMRS with 4 ports left unused.

The example discussed above in c) illustrates how current DMRS assignment is inefficient and inadequate for future MU-MIMO systems where, as the number of co-scheduled users increases, the need for an efficient DMRS assignment to layers of the users becomes even more important in order to reduce the overhead. The problem of c) persists even with the newly proposed extension to 24 layers, where UEs still have to be split into different CDM groups.

The present disclosure concerns a new DMRS design and signaling scheme for uplink transmissions (which may be applied in next generation, e.g. 6G, wireless communication systems).

As will be discussed below, certain examples of the present disclosure seek to enable DMRS patterns that can support more than 24 orthogonal layers on the uplink. Certain examples of the present disclosure seek to enable the same interference pattern at both DMRS locations and data locations of an uplink transmission slot. Certain examples of the present disclosure seek to enable an efficient assignment of DMRSs to layers across all co-scheduled UEs. Certain examples of the present disclosure seek to enable improved performance metrics, such as throughput and Peak-to-Average-Power Ratio, PAPR.

FIG. 4 schematically illustrates a flow chart of an example of a method according to the present disclosure. The steps illustrated in FIG. 4 can represent actions in a method, functionality performed by an apparatus, and/or sections of instructions/code in the computer program.

FIG. 4 can be considered to illustrate a plurality of methods, in the sense that FIG. 4 can be considered to illustrate one or more actions performed by/at a plurality of actors/entities, e.g. a gNB 120 and one or more UE 110. FIG. 4 can therefore be considered to illustrate a plurality of individual methods performed by each respective individual actor/entity of the plurality of the actors/entities. The actions/functions illustrated can be performed by a physical entity (such as an apparatus as described with reference to FIG. 8). The functions described can also be implemented by a computer program (such as is described with reference to FIG. 9).

FIG. 4 shows a gNB 120 sending, to a UE 110, DMRS matrix information 401, wherein the DMRS matrix information is indicative of a row-orthogonal DMRS matrix, P, for the UE to use for the purpose of determining one or more DMRSs for the UE to transmit.

The gNB 120 also sends, to the UE, 110 DMRS submatrix information 402, wherein the DMRS submatrix information is indicative of a submatrix, Pⁱ of the row-orthogonal DMRS matrix that has been assigned to the UE for the UE to use for the purpose of determining at least one DMRS for the UE to transmit.

In block 403, the UE determines one or more DMRSs based, at least in part on the received DMRS matrix information and the DMRS submatrix information.

The gNB 120 the receives, from the UE, the at least one DMRS, wherein the at least one DMRS is determined and transmitted by the UE based, at least in part, on the DMRS matrix information and the DMRS submatrix information received by the UE.

The signals sent and received in FIG. 4 may be electromagnetic signals encoding (in accordance with an encoding process) information, e.g. DMRS matrix information, DMRS submatrix information and one or more DMRS symbols.

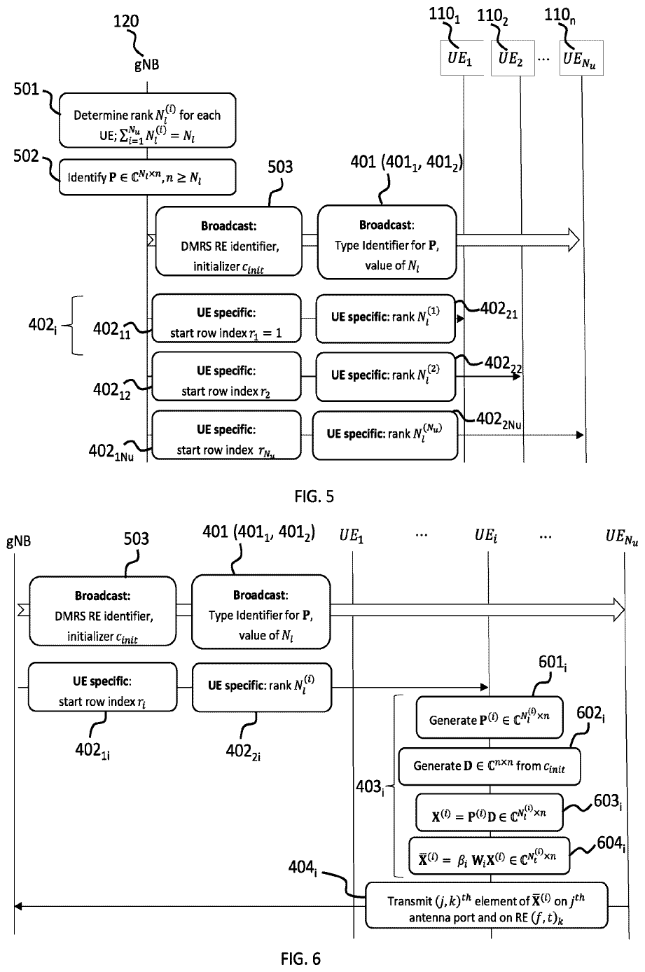

FIGS. 5, 6 and 7 show examples of implementational details of a DMRS design and signaling scheme of the present disclosure, i.e. a signaling scheme for DMRS assignment to each layer of each co-scheduled UE.

In FIGS. 5, 6 and 7, the following are assumed:

There are Nᵤ≥1 transmitters that are co-scheduled on the uplink (i.e. the number of co-scheduled UEs is Nᵤ). Each UE transmits a certain number of layers

$${N}_{l}^{( i )}$$

layers, wherein i=1, . . . , Nᵤ, with

$${\sum }_{i = 1}^{{N}_{u}} {N}_{l}^{( i )} = {N}_{l}$$

(i.e. each UEᵢ has

$${N}_{l}^{( i )}$$

layers and the total number of layers of all of the Nᵤ UEs is Nᵢ).

The following sets out a procedure via which one channel estimate per layer can be obtained for each UE on the uplink.

The DMRS receiver (i.e. the gNB that receives the DMRSs from each co-scheduled UE) identifies a row-orthogonal matrix X, namely a matrix whose rows are orthogonal vectors, (i.e. XX^{H} is a scaled identity matrix). In some examples, the rows of the matrix are orthonormal vectors.

The row-orthogonal matrix X may be called a DMRS matrix. Each row of the matrix corresponds to DMRS symbols transmitted by a certain layer of a UE. The columns of the matric represent resource elements on which the DMRS is transmitted. Accordingly, an (i,j)^{th} element of the DMRS matrix may represent a DMRS symbol to be transmitted by a certain UE (which is assigned the submatrix/row containing this element) on a certain layer in a certain resource element. The DMRS matrix is designed thus in order to be able to separate the layers of all the UEs at a channel estimator so that a channel corresponding to each layer can be estimated without any interference from other layers.

The size/dimensions of the row-orthogonal matrix X is based on the total number of transmitting spatial layers Nₗ from all the Nᵤ co-scheduled UEs, Nᵤ≥1.

The row orthogonal matrix X has Nₗ rows and at least Nₗ columns (i.e. the row orthogonal matrix X has n columns, wherein n≥Nₗ is at least Nₗ). This ensures that the number of columns must be at least equal to the number of rows so that the matrix can be configured to be row-orthogonal (if the matrix were not row orthogonal, then the resulting DMRS would not allow layer separation at a channel estimator). In some examples. n=Nₗ.

Each row of the row orthogonal matrix X gets mapped onto DMRS resources of a resource grid, i.e. DMRS REs of an OFDM PRB.

The row orthogonal matrix X can be determined as a product of a base row-orthogonal matrix P and a pseudo-random diagonal matrix D.

The base row-orthogonal matrix P may be called a “base DMRS matrix”. This has the same property as the DMRS matrix X in that the rows are orthogonal, but it does not have the random component (which is effected via the pseudo-random diagonal matrix D as discussed below). The function of the base DMRS matrix is to enable generation of the overall DMRS matrix X. The base DMRS matrix has a predefined structure (like DFT or Walsh-Hadamard matrix). By making it predefined, this helps the UEs to construct it with minimal signaling (for examples, only the type and size of the base DMRS matrix P needs to be mentioned).

The pseudo-random diagonal matrix D may be called a “random diagonal matrix” which forms a random component of the overall DMRS matrix X. Randomization is needed in order to avoid pilot contamination from UEs in other cells. Without randomization, the gNB of a particular cell runs the risk of estimating a channel that is the addition of the channels of several UEs from different cells. This may lead to highly inaccurate channel estimates for a desired UE.

The base row-orthogonal matrix P has Nₗ rows and n columns, where n≥Nₗ.

Each element of the base row-orthogonal matrix P can have unit magnitude. For example, the elements of P can be of the form e^{j2πθ} for −π≤θ≤π. This may be advantageous in that it allows an out-of-cell interference pattern on DMRS locations to be similar to that on data locations. Having this is desirable since the interference-plus-noise statistics are estimated at the DMRS locations and then used to decode the data at the data locations. Hence, it is desirable to have the statistics be similar at both the DMRS locations and the data locations.

The pseudo-random diagonal matrix D has n rows and n columns, where n is the number of columns of P (and where n≥Nₗ). Each diagonal element of the set of diagonal elements of the pseudo-random diagonal matrix D, takes values independently and randomly from a discrete signal set with zero-mean and unit magnitude elements. The discrete signal set may come from, for example, a Quadrature Phase Shift Keying, QPSK, or 8-PSK constellation. In general, it can be an M−PSK, where M is a power of 2 (e.g. 4-PSK, 8-PSK, 16-PSK, etc).

The diagonal elements of the pseudo-random diagonal matrix D is generated by a pseudo-random generator using a cell-specific initializer cᵢₙᵢₜ as a seed.

In examples of the present disclosure, the gNB sends information to each UE about the row orthogonal matrix X, so as to enable each UEᵢ to determine a submatrix Xⁱ of matrix X that is associated with a respective UEᵢ (i.e. to enable each UEᵢ to determine its own respective submatrix Xⁱ of matrix X, i.e. e.g. one or more rows of matrix X. In this regard, each row of matrix X may be associated with/assigned to a layer, and each row of X may be assigned to a particular UE, wherein the assignment of one or more rows to a particular UE may be based on the number of one or more layers the particular UE has).

As will be discussed below, the submatrix Xⁱ for UEᵢ is used by the UE to determine UEᵢ's one or more DMRS symbols and also control the transmission of UEᵢ's one or more DMRS symbols. Each row of the row orthogonal submatrix Xⁱ gets mapped onto DMRS resources of a resource grid, i.e. DMRS REs of an OFDM PRB, for the slot. The gNB can itself determine X, as well as Xⁱ for each UEᵢ, and hence can associate each received DMRS with the UE that transmitted it, and the gNB can likewise determine the mapping of each row of Xⁱ onto the DMRS resources of a resource grid for the slot.

FIGS. 5 and 6 show an example of a signaling diagram for use with examples of the present disclose. FIG. 5 focuses on signaling from the gNB to a plurality, Nᵤ, of co-scheduled UEs, whilst FIG. 6 focuses on signaling from each co-scheduled UE to the gNB.

With reference to FIG. 5, in block 501, the gNB determines a rank (or number of layers)

$${N}_{l}^{( i )}$$

assigned to each UE. The gNB also determined a total number of layers of all of the Nᵤ UEs

$${\sum }_{i = 1}^{{N}_{u}} {N}_{l}^{( i )} = {N}_{l} .$$

In block 502, the gNB determines a base row-orthogonal matrix P. In the regard, the gNB determines DMRS matrix information. The DMRS matrix information comprises DMRS matrix type information indicative of a type of the base row-orthogonal DMRS matrix for each UE to use to determine the respective one or more DMRSs each UE is to transmit.

The type of base row-orthogonal matrix P could be, for example, a Discrete Fourier Transform, DFT, matrix, or a Walsh matrix. In this example, the type indicates whether the base matrix used is a DFT matrix or a Walsh matrix.

The DMRS matrix information also comprises DMRS matrix size information indicative of first and/or second dimensions of the base row-orthogonal DMRS matrix P that each UE is to use in determining the respective one or more DMRSs each UE is to send. The first and second dimensions may correspond to a number of rows and columns of P. In this example, P has Nₗ rows and n columns. The size of P may be determined based, at least in part, on one or more selected from the group of:
a number of orthogonal DMRSs to be generated and transmitted by the co-scheduled UEs, and
a number of transmitting spatial layers Mi to be supported in the slot (which itself may be determined based on the total number of layers of each UE

$${\sum }_{i = 1}^{{N}_{u}} {N}_{l}^{( i )} = {N}_{l} ) .$$

In this example, P is a Nₗ×n matrix (where n≥Nₗ) whose elements are complex numbers, i.e. P∈ [symbol] ^{N}^{ₗ}^{×n}, n≥Nₗ. In this regard, the size of P (i.e. the number of rows, and the number of columns) is greater than or equal to the total number of transmitting spatial layers Nₗ.

In block 503, the gNB broadcasts resource allocation information, such as an indications as to the REs of the UL slot that are assigned to/reserved for the UEs' transmission of DMRSs In this regard, an indication may be sent of a set [symbol] of n REs over which the DMRSs are to be transmitted by each UE, where [symbol] ={(f,t)ₖ, k=1, . . . , n} and where (f,t)ₖ denotes a (subcarrier index-OFDM symbol index pair of the k^{th} DMRS/pilot symbol within the slot. This set can be predefined so that only a set identifier needs to be transmitted to the UEs.

In block 503, the gNB also broadcasts information indicative of a seed value (which, as will be discussed below, is used by a pseudo-random sequence generator for the generation of the diagonal elements of the pseudo-random diagonal matrix D). In this regard, in this example, the gNB broadcasts an initializer cᵢₙᵢₜ.

In block 401, which corresponds to 401 of FIG. 4, the gNB broadcasts the DMRS matrix information. In this regard, the gNB broadcasts:
DMRS matrix type information 401₁ indicative of a type of the base row-orthogonal DMRS matrix P to be used by each UE (e.g. an indication as to whether P is to be a DFT matrix or a Walsh matrix), and
DMRS matrix size information 401₂ indicative of the dimensions of the base row-orthogonal DMRS matrix P (e.g. an indication of the number of rows and/or columns of P, for instance a value of Nₗ).

In this example, in block 401, the gNB broadcasts, to each UE:
Type Identifier for P 401₁
value of Nₗ 401₂

The gNB separately sends to each UE, DMRS submatrix information 402 that is indicative of a submatrix Pⁱ of the base row-orthogonal DMRS matrix P that has been assigned to each UE for each UE to use in determining at least one DMRS each UE is to transmit. Such UE specific signals 402 are sent from the gNB to each UE separately and are specific to that UE. In contrast, broadcast signals/messages (of 503 and 401) are the same for all UEs. As shown in the example of FIG. 5, the gNB separately sends to each individual UE, information indicative of each UE's respective:
start row index rᵢ of the matrix P 402₁, and
rank

$${N}_{l}^{( i )}$$

402₂ (i.e. the number of layers assigned to the UE).

By sending each UE its respective starting row-index rᵢ and number or layers

$${N}_{l}^{( i )} ,$$

each UEᵢ can then determine/interpret that the row-indices:

$${r}_{i} , {r}_{i} + 1 , … , {r}_{i} + {N}_{l}^{( i )} - 1$$

re assigned to it. In some examples the rank

$${N}_{l}^{( i )}$$

need not be send, for instance in situations where each UE only has 1 layer.

Alternatively, DMRS submatrix information may comprise a set [symbol] ᵢ of

$${N}_{l}^{( i )}$$

row-indices of P assigned to each UEi. Here,

$$\{ 1 , … , {N}_{l} \} = {∐}_{i = 1}^{{N}_{u}} {ℛ}_{i}$$

where ∪ denotes “disjoint union”.

The gNB, by sending the above-mentioned information to each UE, enables each UEᵢ to determine its respective Xⁱ (a submatrix of the orthogonal matrix X) which is itself used to control the DMRS transmission.

FIG. 6 illustrates a signaling diagram, focusing on signaling and processing done by each UE, that shown how the above-described information from the gNB received by each UE is used to enable each UE to determine its respective one or more DMRS symbols 403 and to transmit the same 404.

In block 503 (and as per block 503 in FIG. 5) the gNB broadcasts, to all of the co-scheduled UEs (UE₁ to UE_{N}_{ᵤ}):
DMRS RE identifier, and
initializer cᵢₙᵢₜ

In block 401 (and as per block 401 in FIG. 5) the gNB broadcasts, to all of the co-scheduled UEs, DMRS matrix information namely:
Type Identifier for P,
value of Nₗ

In block 402 (and as per block 401 in FIG. 5) the gNB broadcasts, to each individual UEᵢ, the UEᵢ's respective DMRS submatrix information namely:
start row index rᵢ 402₁ᵢ for UEᵢ
rank

$${N}_{l}^{( i )}$$

402₂ᵢ for UEᵢ

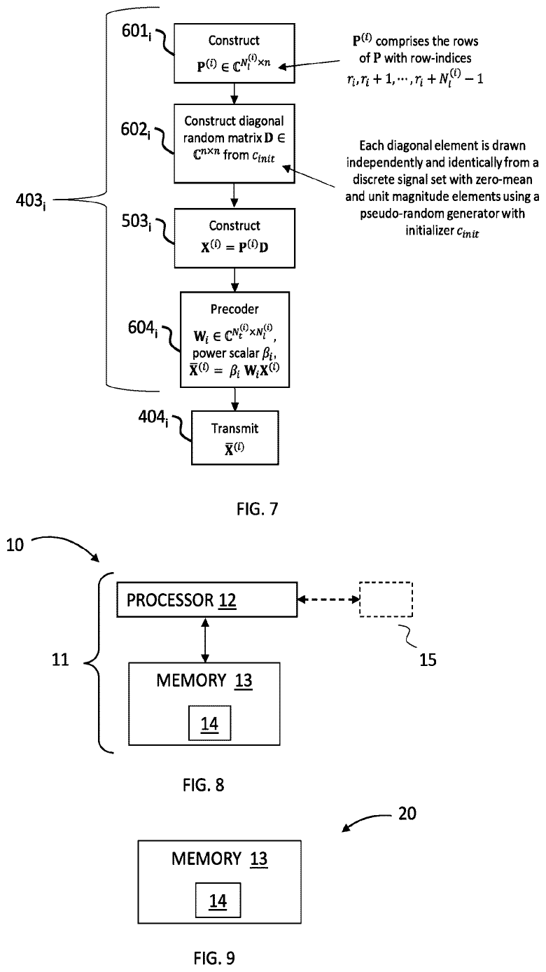

Each UE, i.e. UEᵢ, uses such received information to generate its own one or more DMRSs to be transmitted to the gNB from each antenna port of the UEᵢ as follows, and as also illustrated in FIG. 7:

In block 601, each UE determines/identifies a base row-orthogonal matrix P from the received DMRS matrix information 401, i.e. the type (DFT or Walsh matrices) and size (Nₗ×n) of the base row-orthogonal matrix P sent by the gNB. Each UE then generates its own respective submatrix of P, i.e. Pⁱ, by selecting the relevant rows of the base row-orthogonal matrix P corresponding to the row-indices indicated via the received DMRS submatrix information. In such a manner, the UEi generates

$${P}^{( i )} ∈ {ℂ}^{{N}_{l}^{( i )} \times n}$$

which comprises the relevant rows of P with row-indices belonging to [symbol] ᵢ. (i.e. the set [symbol] ᵢ of

$${N}_{l}^{( i )}$$

row-indices of P assigned to each UEi). In other words, P⁽ⁱ⁾ comprises the rows of P with row-indices rᵢ,

$${r}_{i} + 1 , … , {r}_{i} + {N}_{l}^{( i )} - 1.$$

In block 602, each UE generates a pseudo-random diagonal matrix D using the common seed value, i.e. the initializer cᵢₙᵢₜ that was broadcasted to all the co-scheduled UEs in block 503. Each diagonal element of the pseudo-random diagonal matrix D is drawn independently and identically from a discrete signal set with zero-mean and unit magnitude elements using a pseudo-random generator with initializer cᵢₙᵢₜ

In block 603, each UEi determines X⁽ⁱ⁾ by multiplying P⁽ⁱ⁾ by the pseudo-random diagonal matrix D, wherein

$${X}^{( i )} ∈ {ℂ}^{{N}_{l}^{( i )} \times n} .$$

In effect, X⁽ⁱ⁾ corresponds to the relevant rows of X with row-indices belonging to [symbol] ᵢ.

In block 604, if necessary, a precoder

$${W}_{i} ∈ {ℂ}^{{N}_{t}^{( i )} \times {N}_{l}^{( i )}}$$

and a power scalar βᵢ can be applied by UEi to get

$${\overline{X}}^{( i )} = {β}_{i} {W}_{i} {X}^{( i )} ∈ {ℂ}^{{N}_{t}^{( i )} \times n} ,$$

where

$${N}_{t}^{( i )}$$

is the number of antenna ports at UEi.

In block 404, (j,k)^{th} element of X̅^{(l)} is the DMRS/pilot symbol transmitted by UEi on its j^{th} antenna port and on RE (f,t)ₖ in the slot, where

$$j = 1 , … , {N}_{t}^{( i )} , k = 1 , … , n .$$

Alternatively, if a pre-coder and a power scalar are not used, the (j,k)^{th} element of X⁽ⁱ⁾ may be the DMRS/pilot symbol that is transmitted by UEi on its j^{th} antenna port and on RE (f,t)ₖ in the slot, where

$$j = 1 , … , {N}_{t}^{( i )} , k = 1 , … , n .$$

The messages in the signaling diagrams of FIGS. 5 and 6 may be sent as part of Downlink Control Information DCI (or its equivalent in the next generation/6G).

While the DMRS RE pattern will need to change from its current state (e.g. as illustrated in FIGS. 2 and 3) to accommodate the new DMRS schemes (such as is illustrated in FIGS. 8 and 9), certain signaling features that are involved in the present disclosure for the new DMRS schemes are already in current standards (for example, signaling: single-symbol DMRS or double-symbol DMRS, a start OFDM symbol of the DMRS (i.e. DMRS RE identifier), initializer cᵢₙᵢₜ, rank

$${N}_{l}^{( i )} ) .$$

Advantageously, the method, signaling and functionality described above with respect to FIGS. 5, 6 and 7 may address various of the previously discussed issues/limitations with current/proposed 3GPP standards and conventional DMRS patterns/schemes.

With regard to such previous discussed limitations of the state-of-the-art listed, examples of the present disclosure may address them in the following manner:
1) By using a row-orthogonal matrix X of size Nₗ×n, and having Nₗ>24, it is possible to support in excess of 24 orthogonal DMRS assignments to layers, have in excess of 24 separable spatially multiplexed layers on the uplink.
2) By choosing a base row-orthogonal matrix P such that each entry is of unit magnitude and using a pseudo-random diagonal matrix D wherein each diagonal element of the set of diagonal elements takes values independently and randomly from a discrete signal set with zero-mean and unit magnitude elements in the formation of P; then examples of such base row-orthogonal matrices with each entry being of unit magnitude are DFT matrices (for any value of Nₗ), and Walsh matrices for Nₗ a power of 2. This enables all the layers transmit on the same DMRS REs. Hence, an interference pattern at DMRS locations in a slot would be the same as the interference pattern at data locations in the slot (because all the layers transmit on the same DMRS REs).
3) DMRSs can be jointly assigned to each layer of each co-scheduled UE in an efficient manner. To illustrate this, reference will again be made to UEs A, B, and C that are all co-scheduled with their respective rank/number of spatial layers (or streams) being 3, 2, and 3. As previously discussed, with the current DMRS allocation signaling method on DCI Format 0_1 (Table 7.3.1.1.2-13 & Table 7.3.1.1.2-14 of TS38.212) it is not possible to assign double-symbol Type 1 DMRS even though it supports up to 8 layers (Table 6.4.1.1.3-1 of TS38.211). This is because one would run out of DMRS ports while assigning DMRS to all UEs. Hence, one would need to use the double-symbol Type 2 DMRS—and would end up with only 2 channel estimates per layer per PRB in a slot (since using the Type 2 DMRS reduces the channel estimation accuracy compared to using Type 1 DMRS). On the other hand, in the presently proposed method of allocating DMRS to each layer of each UE in accordance with the present disclosure, this would allow the use of 8 REs per channel estimate per layer (for example, by using a base matrix P being a DFT matrix or Walsh matrix of size 8×8, and assigning: rows {1,2,3} of P to UE A, rows {4,5} of P to UE B, and rows {6,7,8} of P to UE C. Accordingly, one would only need n=8 REs per channel estimate per layer. Therefore, it would be possible to have three channel estimates per layer in a PRB for all the three users if two OFDM symbols were used for DMRS (something which neither the current Type 1 DMRS nor the current Type 2 DMRS can enable).

Whilst FIGS. 5 and 6 show the proposed DMRS scheme of the present disclosure and its associates signaling with respect to a plurality of UEs, wherein each UE is apportioned one or more of the total number of layers (i.e. each UE has

$${N}_{l}^{( i )}$$

layers), It is to be appreciated that the proposed DMRS scheme of the present disclosure could be applied to a scenario where there is only a single UE and the single UE has all Nₗ layers.

It will be understood that each block and combinations of blocks illustrated in FIGS. 4-7 as well as the functions described below, can be implemented by various means, such as hardware, firmware, and/or software including one or more computer program instructions. For example, one or more of the functions described below can be performed by a duly configured apparatus (such as an apparatus, i.e. gNB or UE as appropriate, comprising means for performing various of the described functions). One or more of the functions described can be embodied by a duly configured computer program (such as a computer program comprising computer program instructions which embody the functions described below and which can be stored by a memory storage device and performed by a processor).

As will be appreciated, any such computer program instructions can be loaded onto a computer or other programmable apparatus (i.e. hardware) to produce a machine, such that the instructions when performed on the programmable apparatus create means for implementing the functions specified in the blocks. These computer program instructions can also be stored in a computer-readable medium that can direct a programmable apparatus to function in a particular manner, such that the instructions stored in the computer-readable memory produce an article of manufacture including instruction means which implement the function specified in the blocks. The computer program instructions can also be loaded onto a programmable apparatus to cause a series of operational actions to be performed on the programmable apparatus to produce a computer-implemented process such that the instructions which are performed on the programmable apparatus provide actions for implementing the functions specified in the blocks.

Various, but not necessarily all, examples of the present disclosure can take the form of a method, an apparatus or a computer program. Accordingly, various, but not necessarily all, examples can be implemented in hardware, software or a combination of hardware and software.

Various, but not necessarily all, examples of the present disclosure are described using flowchart illustrations, signaling diagrams and schematic block diagrams. It will be understood that each block (of the flowchart illustrations and block diagrams), and combinations of blocks, can be implemented by computer program instructions of a computer program. These program instructions can be provided to one or more processor(s), processing circuitry or controller(s) such that the instructions which execute on the same create means for causing implementing the functions specified in the block or blocks, i.e. such that the method can be computer implemented. The computer program instructions can be executed by the processor(s) to cause a series of operational block/steps/actions to be performed by the processor(s) to produce a computer implemented process such that the instructions which execute on the processor(s) provide block/steps for implementing the functions specified in the block or blocks.

Accordingly, the blocks support: combinations of means for performing the specified functions; combinations of actions for performing the specified functions; and computer program instructions/algorithm for performing the specified functions. It will also be understood that each block, and combinations of blocks, can be implemented by special purpose hardware-based systems which perform the specified functions or actions, or combinations of special purpose hardware and computer program instructions.

Various, but not necessarily all, examples of the present disclosure provide both a method and corresponding apparatus comprising various modules, means or circuitry that provide the functionality for performing/applying the actions of the method. The modules, means or circuitry can be implemented as hardware, or can be implemented as software or firmware to be performed by a computer processor. In the case of firmware or software, examples of the present disclosure can be provided as a computer program product including a computer readable storage structure embodying computer program instructions (i.e. the software or firmware) thereon for performing by the computer processor.

FIG. 8 schematically illustrates a block diagram of an apparatus 10 for performing the methods, processes, procedures and signaling described in the present disclosure and illustrated in FIGS. 4 to 7, in this regard the apparatus can perform the roles of a gNB/RAN node 120 or a UE 110 in the illustrated and described methods. The component blocks of FIG. 8 are functional and the functions described can be performed by a single physical entity.

The apparatus comprises a controller 11, which could be provided within a device such as a gNB/RAN node 120 or a UE 110.

The controller 11 can be embodied by a computing device, not least such as those mentioned above. In some, but not necessarily all examples, the apparatus can be embodied as a chip, chip set, circuitry or module, i.e. for use in any of the foregoing. As used here ‘module’ refers to a unit or apparatus that excludes certain parts/components that would be added by an end manufacturer or a user.

Implementation of the controller 11 can be as controller circuitry. The controller 11 can be implemented in hardware alone, have certain aspects in software including firmware alone or can be a combination of hardware and software (including firmware).

The controller 11 can be implemented using instructions that enable hardware functionality, for example, by using executable instructions of a computer program 14 in a general-purpose or special-purpose processor 12 that can be stored on a computer readable storage medium 13, for example memory, or disk etc, to be executed by such a processor 12.

The processor 12 is configured to read from and write to the memory 13. The processor 12 can also comprise an output interface via which data and/or commands are output by the processor 12 and an input interface via which data and/or commands are input to the processor 12. The apparatus can be coupled to or comprise one or more other components 15 (not least for example a radio transceiver, sensors, input/output user interface elements and/or other modules/devices/components for inputting and outputting data/commands).

The memory 13 stores a computer program 14 comprising instructions (computer program instructions/code) that controls the operation of the apparatus 10 when loaded into the processor 12. The instructions of the computer program 14, provide the logic and routines that enables the apparatus to perform the methods, processes and procedures described in the present disclosure and illustrated in FIGS. 4 to 7. The processor 12 by reading the memory 13 is able to load and execute the computer program 14.

The computer program instructions may be comprised in a computer program, a non-transitory computer readable medium, a computer program product, a machine-readable medium. The term “non-transitory,” as used herein, is a limitation of the medium itself (i.e. tangible, not a signal) as opposed to a limitation on data storage persistency (e.g. RAM vs. ROM). In some but not necessarily all examples, the computer program instructions may be distributed over more than one computer program.

Although the memory 13 is illustrated as a single component/circuitry it can be implemented as one or more separate components/circuitry some or all of which can be integrated/removable and/or can provide permanent/semi-permanent/dynamic/cached storage.

Although the processor 12 is illustrated as a single component/circuitry it can be implemented as one or more separate components/circuitry some or all of which can be integrated/removable. The processor 12 can be a single core or multi-core processor.

The apparatus can include one or more components for effecting the methods, processes and procedures described in the present disclosure and illustrated in FIGS. 4-7. It is contemplated that the functions of these components can be combined in one or more components or performed by other components of equivalent functionality. The description of a function should additionally be considered to also disclose any means suitable for performing that function. Where a structural feature has been described, it can be replaced by means for performing one or more of the functions of the structural feature whether that function or those functions are explicitly or implicitly described.

Although examples of the apparatus have been described above in terms of comprising various components, it should be understood that the components can be embodied as or otherwise controlled by a corresponding controller or circuitry such as one or more processing elements or processors of the apparatus. In this regard, each of the components described above can be one or more of any device, means or circuitry embodied in hardware, software or a combination of hardware and software that is configured to perform the corresponding functions of the respective components as described above.

The apparatus can, for example (depending on the context/application/implementation), be: a gNB, a RAN node, a server device, a client device, a mobile cellular telephone, a base station in a mobile cellular telecommunication system, a wireless communications device, a hand-portable electronic device, a location/position tag, a hyper tag etc. The apparatus can be embodied by a computing device, not least such as those mentioned above. However, in some examples, the apparatus can be embodied as a chip, chip set, circuitry or module, i.e. for use in any of the foregoing.

In one example, the apparatus is embodied on a hand held portable electronic device, such as a mobile telephone, mobile communication device, wearable computing device or personal digital assistant, that can additionally provide one or more audio/text/video communication functions (for example tele-communication, video-communication, and/or text transmission (Short Message Service (SMS)/Multimedia Message Service (MMS)/emailing) functions), interactive/non-interactive viewing functions (for example web-browsing, navigation, TV/program viewing functions), music recording/playing functions (for example Moving Picture Experts Group-1 Audio Layer 3 (MP3) or other format and/or (frequency modulation/amplitude modulation) radio broadcast recording/playing), downloading/sending of data functions, image capture function (for example using a (for example in-built) digital camera), and gaming functions, or any combination thereof.

In examples where the apparatus is provided within a gNB/RAN node 120, the apparatus comprises:
at least one processor 12; and
at least one memory 13 storing instruction that, when executed by the at least one processor 12, cause the apparatus at least to:
   sending, to one or more User Equipment, UE, demodulation reference signal, DMRS, matrix information indicative of a row-orthogonal DMRS matrix;
   sending, to a UE of the one or more UE, DMRS submatrix information indicative of a submatrix of the row-orthogonal DMRS matrix that has been assigned to the UE;
   receiving, from the UE, said at least one DMRS determined by the UE based, at least in part, on the DMRS matrix information and the DMRS submatrix information.

In examples where the apparatus is provided within a UE 110, the apparatus comprises:
at least one processor 12; and
at least one memory 13 storing instructions that, when executed by the at least one processor 12, cause the apparatus at least to:
   receiving, from a Radio Access Network, RAN, node, demodulation reference signal, DMRS, matrix information indicative of a row-orthogonal DMRS matrix;
   receiving, from the RAN node, DMRS submatrix information indicative of a submatrix of the row-orthogonal DMRS matrix that has been assigned to the UE;
   determining at least one DMRS based at least in part on the DMRS matrix information and the DMRS submatrix information;
   transmitting, to the RAN node, the at least one DMRS.

According to some examples of the present disclosure, there is provided a system (for example at least one gNB/RAN node 120 and at least one UE 110).

The above described examples find application as enabling components of: telecommunication systems; tracking systems, automotive systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things (IOT); Vehicle-to-everything (V2X), virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

FIG. 9, illustrates a computer program 14 which may be conveyed via a delivery mechanism 20. The delivery mechanism 20 can be any suitable delivery mechanism, for example, a machine-readable medium, a computer-readable medium, a non-transitory computer-readable storage medium, a computer program product, a memory device, a solid-state memory, a record medium such as a Compact Disc Read-Only Memory (CD-ROM) or a Digital Versatile Disc (DVD) or an article of manufacture that comprises or tangibly embodies the computer program 14. The delivery mechanism can be a signal configured to reliably transfer the computer program. An apparatus can receive, propagate or transmit the computer program as a computer data signal.

In certain examples of the present disclosure, there is provided computer program comprising instructions, which when executed by an apparatus (e.g. gNB/RAN node 120), cause the apparatus to perform at least the following or for causing performing at least the following:
sending, to one or more User Equipment, UE, demodulation reference signal, DMRS, matrix information indicative of a row-orthogonal DMRS matrix;
sending, to a UE of the one or more UE, DMRS submatrix information indicative of a submatrix of the row-orthogonal DMRS matrix that has been assigned to the UE;
receiving, from the UE, said at least one DMRS determined by the UE based, at least in part, on the DMRS matrix information and the DMRS submatrix information.

In certain examples of the present disclosure, there is provided a computer program comprising instructions, which when executed by an apparatus (e.g. UE 110), cause the apparatus to perform at least the following or for causing performing at least the following:
receiving, at a User Equipment, UE, from a Radio Access Network, RAN, node, demodulation reference signal, DMRS, matrix information indicative of a row-orthogonal DMRS matrix;
receiving, at the UE from the RAN node, DMRS submatrix information indicative of a submatrix of the row-orthogonal DMRS matrix that has been assigned to the UE;
determining, at the UE, at least one DMRS based at least in part on the DMRS matrix information and the DMRS submatrix information;
transmitting, from the UE to the RAN node, the at least one DMRS.

References to ‘computer program’, ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

There now follows a further discussion of details, implementation and advantages of examples of the present description.

### Setup and Notation

We assume that Cell c (such as a gNB/RAN node 120), with Nᵣ base-station antennas, serves a total of

$${N}_{{l}_{c}} = {\sum }_{i} {N}_{l}^{( i )}$$

layers/streams nom all the co-scheduled users in Cell c.

A signal model is defined as:

$$y = H x + {n}_{i n t} + {n}_{w} , \qquad ( 1 )$$

where:

$$y ∈ {ℂ}^{{N}_{r} \times 1} , H ∈ {ℂ}^{{N}_{r} \times {N}_{{l}_{c}}} , x ∈ {ℂ}^{{N}_{{l}_{c}} \times 1} ,$$

and nᵢₙₜ+n_{w} is I+N with covariance Rₙ∈ [symbol] Nᵣ×Nᵣ.

We suppose that n_{w}~ [symbol] (0, σ²I_{N}_{ᵣ}). We use subscripts c, v to specify the v^{th} resource element in a PRB for Cell c, so

$${y}_{c , v} = {H}_{c , v} {x}_{c , v} + {n}_{int , c , v} + {n}_{w , c , v} . \qquad ( 2 )$$

Let [symbol] _{c} denote the set of pilot REs (such as DMRS symbols) for Cell c and [symbol] _{c} denote the set of data REs.

The I+N covariance is re-estimated at the cell using the estimated channel and the pilots at [symbol] _{c}. This re-estimate is used subsequently for noise-whitening and symbol detection at [symbol] _{c}

A goal of certain examples of the disclosure is that the same interference pattern might be present at both DMRS locations [symbol] _{c} and the data locations [symbol] _{c} and that DMRS codes should be such that the effective Signal-to-Interference Noise Ratio, SINR, for channel estimation is maximized for a given level of overhead.

$$Let {H}_{c v} \text{?} [ {h}_{c v}^{( 1 )} , {h}_{c v}^{( 2 )} , … , {h}_{c , v}^{( {N}_{{l}_{c}} )} ] , {x}_{c , v} {\text{?} [ {x}_{c , v}^{( 1 )} , {x}_{c , v}^{( 2 )} , … , {x}_{c , v}^{( {N}_{{l}_{c}} )} ]}^{T}$$

with

$${h}_{c , v}^{( i )}$$

denoting the channel vector corresponding to Layer i (for Cell c) which transmits symbol

$${x}_{c , v}^{( i )} .$$

Let [symbol] [symbol] {v₁, . . . , vₙ_{_{c}}} be a set of resource elements where

$${H}_{c , {ν}_{1}} \approx … \approx {H}_{c , {ν}_{{N}_{{l}_{c}}}} = {H}_{c , 𝒱} .$$

We must have | [symbol] |=n_{c}≥Nₗ_{_{c}} for estimating H_{c,} [symbol] . Therefore, we have

$$[ {Y}_{c , 𝒱} \text{?} [ {y}_{c , {v}_{1}} , {y}_{c , {v}_{2}} , … , {y}_{c , {v}_{{N}_{{l}_{c}}}} ] = [ \text{} {h}_{c , {v}_{1}}^{( 1 )} , {h}_{c , {v}_{1}}^{( 2 )} , … , {h}_{c , {v}_{1}}^{( {N}_{l} )} ] [ \begin{matrix}{x}_{c , {v}_{1}}^{( 1 )} & … & {x}_{c , {v}_{{n}_{c}}}^{( 1 )} \\ ⋮ & ⋱ & ⋮ \\ {x}_{c , {v}_{1}}^{( {N}_{l} )} & … & {x}_{c , {v}_{{n}_{c}}}^{( {N}_{l} )}\end{matrix} ] + {N}_{c , 𝒱} \qquad ( 3 )$$

$$where {N}_{c , 𝒱} \text{?} [ {n}_{int , c , {v}_{1}} + {n}_{w , c , {v}_{1}} , … , {n}_{int , c , {v}_{{n}_{c}}} + {n}_{w , c , {v}_{{n}_{c}}} ] .$$

$$Let {X}_{c , 𝒱} \text{?} [ {x}_{c , {v}_{1}} , … , {x}_{c , {v}_{{n}_{c}}} ] = [ \begin{matrix}{x}_{c , {v}_{1}}^{( 1 )} & … & {x}_{c , {v}_{{n}_{c}}}^{( 1 )} \\ ⋮ & ⋱ & ⋮ \\ {x}_{c , {v}_{1}}^{( {N}_{{l}_{c}} )} & … & {x}_{c , {v}_{{n}_{c}}}^{( {N}_{{l}_{c}} )}\end{matrix} ] . \qquad ( 4 )$$

$$So , we have {Y}_{c , 𝒱} = {H}_{c , 𝒱} {X}_{c , 𝒱} + {N}_{c , 𝒱} . \qquad ( 5 )$$

With n_{int,c,v}=Σ_{c′≠c}H_{c′→c,v}x_{c′,v}, where H_{c′→c,v}∈ [symbol] ^{N}^{ᵣ}^{×N}^{_{lc′}} denotes the channel from the interfering users in Cell c′ to Cell c on RE v (a total of N_{lc′} interfering layers), we have

$${N}_{c , 𝒱} = {\sum }_{{c}^{′} \neq c} {H}_{{c}^{′} \to c , 𝒱} {X}_{{c}^{′} , 𝒱} + {N}_{w , c , 𝒱} \qquad ( 6 )$$

where

$${N}_{w , c , 𝒱} \text{?} [ {n}_{w , c , {v}_{1}} , … , {n}_{w , c , {v}_{{N}_{{l}_{c}}}} ] and {X}_{{c}^{′} , 𝒱} ∈ {ℂ}^{{N}_{{l}_{{c}^{′}}}} ∈ {ℂ}^{{N}_{{l}_{{c}^{′}}} \times {n}_{c}}$$

is the symbol matrix transmitted by the co-scheduled users in Cell c′ (includes possibly both data and pilots) in the resource elements indexed by [symbol] .

Suppose that each element of X_{c,} [symbol] is constrained to have average magnitude at most unity. We use the notation

$${x}_{c , 𝒱}^{( p )} .$$

to specify that the symbols are pilots and not data.

Let

$${X}_{c , 𝒱}^{( p )}$$

denote the pilot matrix with orthogonal rows so that

$${{X}_{c , 𝒱}^{( p )} ( {X}_{c , 𝒱}^{( p )} )}^{H} = α {I}_{{N}_{{l}_{c}}}$$

where 1≤α≤n_{c}. Then, from (5), we have

$$\frac{1}{\sqrt{α}} {{Y}_{c , 𝒱} ( {X}_{c , 𝒱}^{( p )} )}^{H} = \sqrt{α} {H}_{c , 𝒱} + \frac{1}{\sqrt{α}} {\sum }_{{c}^{′} \neq c} {H}_{{c}^{′} \to c , 𝒱} {{X}_{{c}^{′} , 𝒱} ( {X}_{c , 𝒱}^{( p )} )}^{H} + \frac{1}{\sqrt{α}} {{N}_{W , c , 𝒱} ( {X}_{c , 𝒱}^{( p )} )}^{H} . \qquad ( 7 )$$

Using the identity vec(AB)=(B^{T}⊗Iₘ)vec(A) for any matrices A∈ [symbol] ^{m×n}, B∈ [symbol] ^{n×k} with vec(·) denoting the column-wise stacking of the elements of a matrix, it is straightforward to see that vec

$$( \frac{1}{\sqrt{α}} {{N}_{W , c , 𝒱} ( {X}_{c , 𝒱}^{( p )} )}^{H} )$$

is jointly Gaussian with covariance

$${σ}^{2} {I}_{{N}_{r} {N}_{{l}_{c}}}$$

due to

$$\frac{1}{\sqrt{α}} {( {X}_{c , 𝒱}^{( p )} )}^{H}$$

being a column orthogonal matrix.

From (7), we see that in order to estimate any channel vector

$${h}_{c , {v}_{1}}^{( i )}$$

corresponding to Layer i, we have the following equation:

$$( {\overline{x}}_{c , {v}_{i}}^{T} ⊗ {I}_{{N}_{r}} ) vec ( {Y}_{c , 𝒱} ) = \sqrt{α} {h}_{c , {v}_{1}}^{( i )} + {\sum }_{{c}^{′} \neq c} ( {\overline{x}}_{{c}^{′} , c , {v}_{i}}^{T} ⊗ {I}_{{N}_{r}} ) vec ( {H}_{{c}^{′} \to c , 𝒱} ) + {n}_{c , {v}_{i}}^{′} \qquad ( 8 )$$

where x̅^{(p)}_{c,v}_{ᵢ} ∈ [symbol] ⁿ^{_{c}}^{×1} is the i^{th} column

$$of \frac{1}{\sqrt{α}} {( {X}_{c , 𝒱}^{( p )} )}^{H}$$

### (or the Hermitian or the i^{th} row

$$of \frac{1}{\sqrt{α}} {X}_{c , 𝒱}^{( p )} ) , {\overline{x}}_{{c}^{′} , c , {v}_{i}} ∈ {ℂ}^{{n}_{c ′} \times 1}$$

is the i^{th} column of

$$\frac{1}{\sqrt{α}} {{X}_{{c}^{′} , 𝒱} ( {X}_{c , 𝒱}^{( p )} )}^{H} , and {n}_{c , {v}_{i}}^{′} ∼ 𝒞𝒩 ( 0 , {σ}^{2} {I}_{{N}_{r}} ) .$$

Recall that

$${R}_{n} = 𝔼 [ ( {\sum }_{{c}^{′} \neq c} {H}_{{c}^{′} \to c , v} {x}_{{c}^{′} , v} ) {( {\sum }_{{c}^{′} \neq c} {H}_{{c}^{′} \to c , v} {x}_{{c}^{′} , v} )}^{H} ] + {σ}^{2} {I}_{{N}_{r}} = 𝔼 [ {\sum }_{{c}^{′} \neq c} {H}_{{c}^{′} \to c , v} {H}_{{c}^{′} \to c , v}^{H} ] + {σ}^{2} {I}_{{N}_{r}} \qquad ( 9 )$$

due to the independence of the symbols of each layer in each cell. The first expectation is over the channels from other cells (both in frequency and time within the nearest PRBs of interest in the slot), and over the symbols of each layer in each cell. The second expectation is only over the channels.

Returning to (7), and the fact that x̅_{c′,c,v}_{ᵢ}∈ [symbol] ⁿ^{_{c′}}^{×1} is the i^{th} column of

$$\frac{1}{\sqrt{α}} {{X}_{{c}^{′} , 𝒱} ( {X}_{c , 𝒱}^{( p )} )}^{H} ,$$

we have

$$𝔼 [ ( {\sum }_{{c}^{′} \neq c} ( {\overline{x}}_{{c}^{′} , c , {v}_{i}}^{T} ⊗ {I}_{{N}_{r}} ) vec ( {H}_{{c}^{′} \to c , 𝒱} ) ) {( {\sum }_{{c}^{′} \neq c} ( {\overline{x}}_{{c}^{′} , c , {v}_{i}}^{T} ⊗ {I}_{{N}_{r}} ) vec ( {H}_{{c}^{′} \to c , 𝒱} ) )}^{H} ] = 𝔼 [ ( {\sum }_{{c}^{′} \neq c} {H}_{{c}^{′} \to c , 𝒱} {\overline{x}}_{{c}^{′} , c , {v}_{i}} ) {( {\sum }_{{c}^{′} \neq c} {H}_{{c}^{′} \to c , 𝒱} {\overline{x}}_{{c}^{′} , c , {v}_{i}} )}^{H} ] = 𝔼 [ {\sum }_{{c}^{′} , {c}^{″} \neq c} {H}_{{c}^{′} \to c , 𝒱} {\overline{x}}_{{c}^{′} , c , {v}_{i}} {\overline{x}}_{{c}^{″} , c , {v}_{i}}^{H} {H}_{{c}^{″} \to c , 𝒱}^{H} ] . \qquad ( 10 )$$

If

$$𝔼 [ {\overline{x}}_{{c}^{′} , c , {v}_{i}} {\overline{x}}_{{c}^{″} , c , {v}_{i}}^{H} ] = {I}_{{n}_{{c}^{′}}} for {c}^{′} = {c}^{″}$$

and O otherwise (satisfied for data symbols),

$$𝔼 [ {\sum }_{{c}^{′} , {c}^{″} \neq c} {H}_{{c}^{′} \to c , 𝒱} {\overline{x}}_{{c}^{′} , c , {v}_{i}} {\overline{x}}_{{c}^{″} , c , {v}_{i}}^{H} {H}_{{c}^{′} \to c , 𝒱}^{H} ] = 𝔼 [ {\sum }_{{c}^{′} \neq c} {H}_{{c}^{′} \to c , v} {H}_{{c}^{′} \to c , v}^{H} ] \qquad ( 11 )$$

and from (7),

$${y}_{c , {v}_{i}}^{′} = \sqrt{α} {h}_{c , {v}_{1}}^{( i )} + {n}_{int , c , {v}_{i}}^{′} + {n}_{c , {v}_{i}}^{′} . \qquad ( 12 )$$

where

$${y}_{c , {v}_{i}}^{′} \text{?} ( {( {\overline{x}}_{c , {v}_{i}}^{( p )} )}^{T} ⊗ {I}_{{N}_{r}} ) vec ( {Y}_{c , v} ) ,$$

and n_{int,cv}_{ᵢ}′ [symbol] Σ_{c′≠c}(x̅_{c′c,v}_{ᵢ}^{T}⊗I_{N}_{ᵣ})vec(H_{c′→c,v}) such that

$${n}_{int , c , {v}_{i}}^{′} + {n}_{c , {v}_{i}}^{′}$$

has covariance Rₙ. Here, α is the multiplexing gain that can be obtained by suitable pilot matrix design.

### DMRS Matrix Design Criteria

With the setup and notation as described above, the following criteria for DMRS matrix design are sufficient to satisfy (11) and maximize α in (12) (subject to an overall power constraint):
C1 Row orthogonal pilot matrix

$${X}_{c , v}^{( p )} ∈ {ℂ}^{{N}_{{l}_{c}} \times {n}_{c}}$$

with zero mean, average unit magnitude elements. This is available for any value of n_{c}=Nₗ_{_{c}}: (scaled) DFT matrices, or Walsh-Hadamard matrices for Nₗ_{_{c}} a power of 2. So, for any Cell c

$${X}_{c , v}^{( p )} {( {X}_{c , v}^{( p )} )}^{H} = {n}_{c} {I}_{{N}_{{l}_{c}}} \qquad C1 \text{.1}$$

(maximizes the multiplexing gain)

$$𝔼 [ {X}_{c , v}^{( p )} ] = {O}_{{N}_{{l}_{c}} \times {n}_{c}} \qquad C1 \text{.2}$$

(zero mean symbols)

$$𝔼 [ {\vert {[ {X}_{c , v}^{( p )} ]}_{i , j} \vert}^{2} ] = 1 , ∀ 1 \leq i \leq {N}_{{l}_{c}} , 1 \leq j \leq {n}_{c} \qquad C1 \text{.3}$$

(average unit magnitude symbols).
C2 Some degree of independence and randomness between such pilot matrices across cells to satisfy (11). Note that (11) is satisfied by default if X_{c′,V} in Cell c′ contains data symbols from a symmetric, zero-mean, unit-energy constellation like Quadrature Amplitude Modulation, QAM. It is only if it is a pilot matrix that we need to carefully design it while also having to satisfy Criterion 1. So, for any two distinct cells c and c′

$$𝔼 [ {X}_{{c}^{′} , v} {( {X}_{c , v}^{( p )} )}^{H} ] = 𝔼 [ {X}_{{c}^{′} , v} ] 𝔼 [ {( {X}_{c , v}^{( p )} )}^{H} ] = {O}_{{N}_{{l}_{{c}^{′}}} \times {N}_{{l}_{c}}} . \qquad C2 \text{.1}$$

$$𝔼 [ {\vert {[ {{X}_{{c}^{′} , v} ( {X}_{c , v}^{( p )} )}^{H} ]}_{i , j} \vert}^{2} ] = 1 , ∀ 1 \leq i \leq {N}_{{l}_{{c}^{′}}} , ∀ 1 \leq j \leq {N}_{{l}_{c}} . \qquad C2 \text{.2}$$

This is because the i^{th} column of

$$\frac{1}{\sqrt{{N}_{{l}_{c}}}} {X}_{{c}^{′} , v} {( {X}_{c , v}^{( p )} )}^{H}$$

has expected L2-norm equal to Nₗ_{_{c′}}. We would like to distribute this evenly across layers because otherwise, the interference would be concentrated across only a few layers from neighbouring cells and the I+N covariance would be different for channel estimation from that of data estimation.

These two are achieved for minimum length (n_{c}=Nₗ_{_{c}}) by choosing

$${X}_{c , v}^{( p )} = {PD}_{c}$$

where:
P∈ [symbol] ^{N}^{_{lc}}^{×N}^{_{lc}} is a scaled DFT matrix (or Walsh matrix for Nₗ_{_{c}} a power of 2) with unit magnitude elements.

$${D}_{c} = diag ( {d}_{1} , … , {d}_{{N}_{{l}_{c}}} ) , with {\{ {d}_{i} \}}_{i = 1}^{{N}_{{l}_{c}}}$$

being i.i.d. uniform random variables taking values from a symmetric PSK signal set of sufficiently high cardinality (4-8, scales linearly with number of interfering cells).

### DFT and Walsh Matrices

As indicated above, X_{c,V}=PD_{c}, where

$$P = {[ {e}^{- \frac{jmn 2 π}{N}} ]}_{m , n = 0 , … , {N}_{{l}_{c}} - 1}$$

which is the scaled Nₗ_{_{c}}×Nₗ_{_{c}} DFT matrix.

When Nₗ_{_{c}} is a power of 2, e.g. Nₗ_{_{c}}=2^{k} for a natural number k∈ [symbol] , we can use P=H(2^{k}) where

$$H ( 2 ) = [ \begin{matrix}1 & 1 \\ 1 & - 1\end{matrix} ] ,$$

$$H ( {2}^{k} ) = [ \begin{matrix}H ( {2}^{k - 1} ) & H ( {2}^{k - 1} ) \\ H ( {2}^{k - 1} ) & - H ( {2}^{k - 1} )\end{matrix} ] , ∀ 2 \leq k ∈ ℕ$$

### Example DMRS Resource Element Allocation

From the analysis above (under the heading Setup and notation), we obtain a single channel matrix Ĥ_{c,} [symbol] for all the REs in the set [symbol] . This Ĥ_{c,} [symbol] is an estimate for the average of all actual channel matrices for the REs in the set [symbol] , i.e., an estimate of

$$\frac{1}{\vert v \vert} {\sum }_{i = 1}^{{n}_{c}} {H}_{c , {v}_{i}} .$$

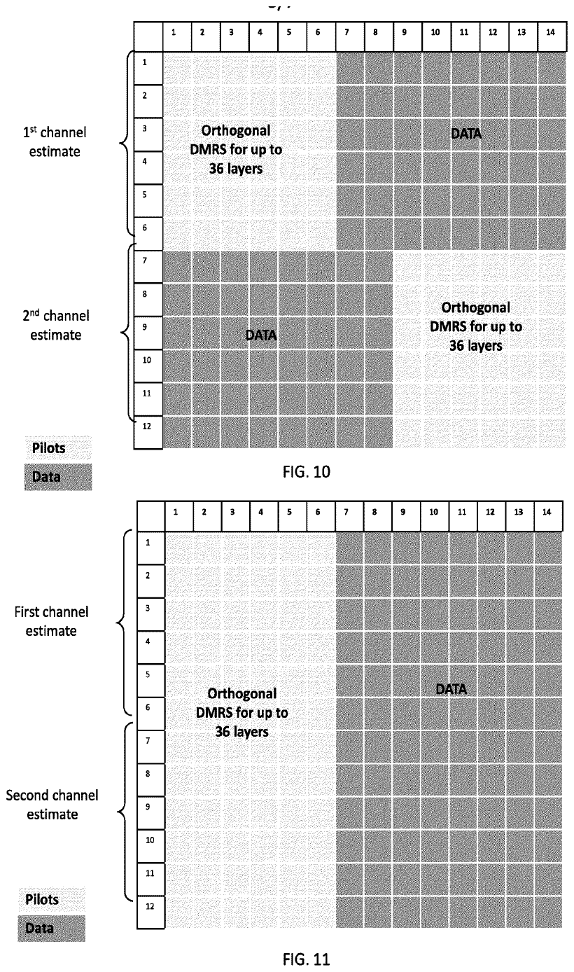

In the event that the mobilities of the co-scheduled UEs is very low, one can use an example DMRS-RE allocation as shown in FIG. 10.
1) This allocation provides orthogonal DMRS for up to 36 layers.
2) For any number of layers Nₗ below 36, a predetermined subset of these REs (with cardinality equal to 2Nₗ if Nₗ>9, or 3Nₗ if Nₗ≤8) can be used for DMRS and the remaining for data. In such a case, we can obtain 2 (if Nₗ>8) or 3 (if Nₗ≤8) channel estimates per layer per PRB.
3) If the delay spread is moderately high, one can interpolate to obtain the channel estimates across all the subcarriers in a PRB.

FIG. 10 illustrates an example pattern of DMRS REs for supporting up to 36 spatial layers with 2 channel estimates per layer per PRB. Such a DMRS pattern may be applicable for situations with low UE mobility

In the event that the mobilities of the co-scheduled UEs is moderately high, one can use an example DMRS-RE allocation as shown in FIG. 11.
1) This allocation also provides orthogonal DMRS for up to 36 layers.
2) For any number of layers Nₗ below 36, a predetermined subset of these REs (with cardinality equal to 2Nₗ if Nₗ>8, or 3Nₗ if Nₗ≤8) can be used for DMRS and the rest for data. In such a case, we can obtain 2 (if Nₗ>8) or 3 (if Nₗ≤8) channel estimates per layer per PRB.
3) The channel estimates across subcarriers in a PRB and across OFDM symbols in a slot can then be interpolated from the obtained channel estimates.

FIG. 11 illustrates another example pattern of DMRS REs for supporting up to 36 spatial layers with 2 channel estimates per layer per PRB. Such a DMRS pattern may be applicable for situations with high UE mobility. It is remarked however that, in situations/scenarios where there is/expected to be high mobility, this would not be conducive for MU-MIMO co-scheduling, so the problem of orthogonal DMRS allocation for more than 12 layers would likely not arise in such a situation.

### Simulations

There now follows a discussion of simulation parameters for performing a multi-cell, multi-link-level simulation, MCMLLS. The purpose of these simulations is to support the above discussed proposed benefits of examples of the present disclosure.

The simulation code was written in Python and TensorFlow, and we consider a 21-cell, 210-UE setting with the following parameters.

Site Parameters

| | |
|---|---|
| # sites | 7 |
| # cells/site | 3 |
| ISD | 200 m |
| # users | 210 |

Channel Parameters

| Channel Model | 38.901 Urban Micro | |
|---|---|---|
| f_{c} | 7 | GHz |
| Subcarrier-spacing | 30 | kHz |
| # PRBs | 24 | |
| Channel BW | 8.64 | MHz |

Other Parameters

| Target received power P₀ | −100 | dBm |
|---|---|---|
| Open loop power control fractional | 0.85 | |
| path-loss compensation factor α | | |
| Maximum total output power per UE | 23 | dBm |
| Noise figure at cell | 0 | dB |
| Number of independent user drops | 5 | |
| Number of slots per drop | 100 | |
| BW allocation to UE | Variable according to Tx | |
| | power limit | |
| HARQ max number of retransmissions | 3 | |
| Slot duration | 0.5 | ms |

| | |
|---|---|
| Channel estimation | Joint LMMSE across antennas |
| Interference + noise covariance | Practical estimation at pilot |
| estimation | locations |
| Beamforming | None, full array processing |

Antenna parameters

| | |
|---|---|
| Cell antenna array | 256-TRX (8 × 16 × 2) |
| # Antenna elements | 768 (3 × 1 subarray) |
| UE antenna array | 4-TRX (1 × 2 × 2) |

Site antenna configuration

| | |
|---|---|
| Mechanical bearing | [0°, 120°, −120°] |
| Mechanical down tilt | 0° |
| Slant angle | 0° |
| Electrical panning | 0° |
| Electrical uptilt | −7.5° |
| HPBW in the azimuth | 95° |
| HPBW in the elevation | 95° |
| Subarray size | 3 × 1 (row × col) |
| AE row spacing | 0.65λ |
| AE column spacing | 0.5λ |
| Maximum sub-array gain | 9.5 dBi |
| Slant angles (degrees) in the panel | [45°, −45°] |
| in the local coordinate system | |

The users are scheduled in a round-robin manner as follows:
The set of served users in each cell is split into maximal subsets based on the cross-correlation between the principal eigenvectors of their respective channel covariances at cell.
Maximal subsets are served in a round-robin manner.
Layers/user are selected based on how many eigenvalues of channel covariance at user are within 3 dB from the principal eigenvalue.

We now compare the performances of the following 4 different DMRS schemes:
1) 5G Type 1 DMRS with different scrambling IDs and joint multi-user (MU)-IRC on the full antenna array. In this case, symbols 3 and 4 are used for DMRS as shown in FIG. 2. For layers up to 8, a certain scrambling ID is used. For layers from 9-16, a different scrambling ID is used, and so on for layers from 17-24 . . . . Therefore, only subsets of the layers (of 8 layers in each subset at most) see orthogonal DMRS while across the subsets, the DMRS of layers are non-orthogonal. The advantage with this technique is that there is no need for additional overhead and this can be employed using the current 5G standards. The disadvantage is that the non-orthogonality of the DMRS across all layers will likely severely degrade the throughput performance.
2) The same setting as above, but with single user (SU)-IRC using user-specific eigen beamforming with 16 beams per user. Since beamforming is user-specific, there is a better ability to separate layers than in the previous case. So, this scheme retains the low-overhead advantage of the previous case with better expected throughput performance.
3) The proposed design scheme detailed under the heading Setup and notation, except that instead of a DFT or Walsh matrix as the base row-orthogonal code, we use the existing length 4 orthogonal cover code (OCC) in 5G. This means that the above-mentioned Criterion C1.3 is not satisfied while the remaining ones are. Also, the number of DMRS REs per channel estimate can be larger than the sum of all layers. MU-IRC is performed on the full antenna array. This would be similar in effect to the newly proposed DMRS extensions in the current standard for supporting up to 24 layers.
4) The proposed design scheme detailed under the heading Setup and notation, using DFT matrices as the base row-orthogonal code. Here, the number of DMRS REs per channel estimate equals the sum of all layers. MU-IRC is performed on the full antenna array.

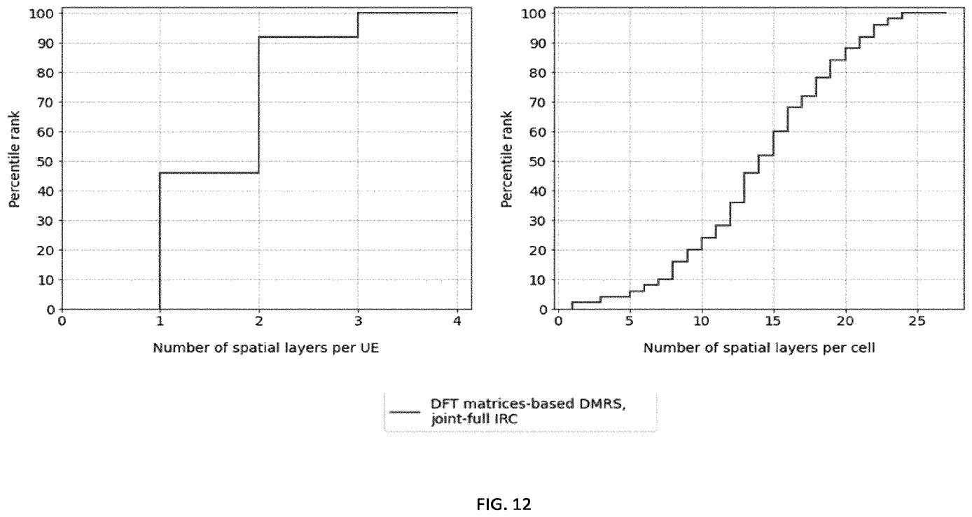

FIG. 12 shows plots of the percentiles of the number of spatial layers per user and percentiles of the total number of spatial layers per cell that were achieved using the described round-robin scheduling method (uniform for all the schemes). The median number of layers/slot was found to be 14 (the maximum was set to 32 but the actual number was seldom beyond 24).

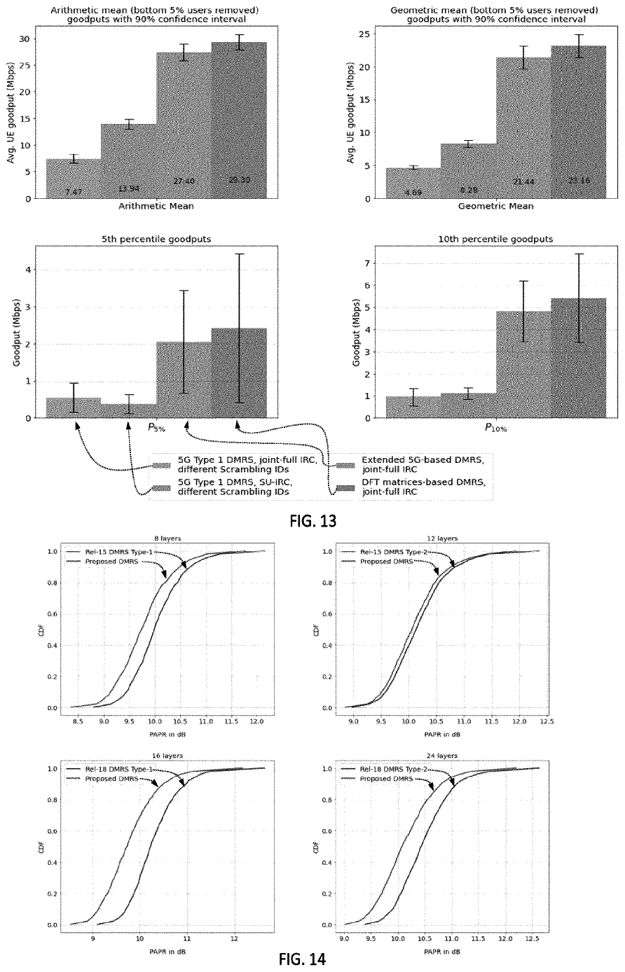

FIG. 13 shows plots of the achieved goodput (the actual message bit rate excluding the overhead and hybrid automatic repeat request, HARQ, retransmissions) for the 4 schemes. The advantage of the proposed schemes, i.e. schemes 3) and 4), is quite evident. Compared to scheme 3) that uses length-4 OCC, there is a 10% improvement in the arithmetic mean goodput of scheme 4) by using DFT matrices. This is because scheme 4) ensures that the interference pattern is the same on both DMRS and data REs. Both the proposed schemes 3) and 4) of the present disclosure significantly outperform the first two schemes (which is the best that can be achieved by the state of the art).

FIG. 14 shows a comparison of Cumulative Distribution Functions, CDFs, computed empirically, of PAPR for the proposed scheme and the existing schemes. The plots are for 8, 12, 16, and 24 layers. We have used a 4096-point FFT with 275 PRBs. The X-axis represents the PAPR in dB. The simulations were carried out for 1000 independent cases to plot the CDF. In general, the PAPR of the proposed scheme is better than the ones in the standards. This is because the proposed scheme makes the interference pattern be similar on both data and DMRS REs. The PAPRs would not be worsened because of this fact.

To summarize, the simulation results show the following:
1. The bars of FIG. 13 representing the proposed DMRS scheme, i.e. schemes 3) and 4) discussed above, show the gains that can be achieved by using the proposed scheme which supports more than 12 orthogonal layers. The bars of FIG. 13 representing DMRS schemes that exist in current standards cannot support more than 12 layers.
2. The bars for proposed DMRS scheme 3) [where the interference pattern at DMRS locations is not similar to that at the data locations] vs the bars for proposed DMRS scheme 3) [where the patterns are similar at both DMRS and data locations due to the proposed code design] shows the effect of having an interference pattern at DMRS locations being different from an interference pattern at data locations because not all the layers transmit on the same DMRS Res. The bars for proposed DMRS scheme 4) is for DMRS that was designed with P having unit magnitude elements (DFT matrices) while bars for scheme 3) is where the DMRS does not have this feature. In such a manner, scheme 4) provides s a DMRS configuration/transmission scheme/pattern (and associated signalling for same) that supports transmission of Nₗ orthogonal DMRS signals over Nₗ DMRS RES wherein all of the Nₗ orthogonal DMRS signals are transmitted over the same Nₗ REs (i.e. each of the Nₗ orthogonal DMRS signals is transmitted over the same Nₗ DMRS REs).
3. The bars for proposed DMRS schemes 3) and 4) correspond to the case where orthogonal DMRSs have been efficiently assigned to layers across all the UEs (as compared to the bars for the current DMRS technique in the standards).

Although specific terms are employed herein, they are used in a generic and descriptive sense only and not for purposes of limitation. Features described in the preceding description can be used in combinations other than the combinations explicitly described. Although functions have been described with reference to certain features, those functions can be performable by other features whether described or not. Although features have been described with reference to certain examples, those features can also be present in other examples whether described or not. Accordingly, features described in relation to one example/aspect of the disclosure can include any or all of the features described in relation to another example/aspect of the disclosure, and vice versa, to the extent that they are not mutually inconsistent. Although various examples of the present disclosure have been described in the preceding paragraphs, it should be appreciated that modifications to the examples given can be made without departing from the scope of the invention as set out in the claims.

The term ‘comprise’ is used in this document with an inclusive not an exclusive meaning. That is any reference to X comprising Y indicates that X can comprise only one Y or can comprise more than one Y. If it is intended to use ‘comprise’ with an exclusive meaning then it will be made clear in the context by referring to “comprising only one . . . ” or by using “consisting”.

In this description, the wording ‘connect’, ‘communication’ and their derivatives mean operationally connected/in communication. It should be appreciated that any number or combination of intervening components can exist (including no intervening components), i.e. so as to provide direct or indirect connection/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), retrieving/accessing (for example, retrieving/accessing data in a memory), obtaining and the like. Also, “determine/determining” can include resolving, selecting, choosing, establishing, and the like.

References to a parameter (for example: Nₗ, n,

$${N}_{l}^{( i )} ,$$

rᵢ, base row orthogonal matrix type . . . ), or value of a parameter, should be understood to refer to “data indicative of”, “data defining” or “data representative of” the relevant parameter/parameter value if not explicitly stated (unless the context demands otherwise). The data may be in any way indicative of the relevant parameter/parameter value, and may be directly or indirectly indicative thereof.

In this description, reference has been made to various examples. The description of features or functions in relation to an example indicates that those features or functions are present in that example. The use of the term ‘example’ or ‘for example’, ‘can’ or ‘may’ in the text denotes, whether explicitly stated or not, that such features or functions are present in at least the described example, whether described as an example or not, and that they can be, but are not necessarily, present in some or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class.

In this description, references to “a/an/the” [feature, element, component, means . . . ] are used with an inclusive not an exclusive meaning and are to be interpreted as “at least one” [feature, element, component, means . . . ] unless explicitly stated otherwise. That is any reference to X comprising a/the Y indicates that X can comprise only one Y or can comprise more than one Y unless the context clearly indicates the contrary. If it is intended to use ‘a’ or ‘the’ with an exclusive meaning then it will be made clear in the context. In some circumstances the use of ‘at least one’ or ‘one or more’ can be used to emphasise an inclusive meaning but the absence of these terms should not be taken to infer any exclusive meaning. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The presence of a feature (or combination of features) in a claim is a reference to that feature (or combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

In the above description, the apparatus described can alternatively or in addition comprise an apparatus which in some other examples comprises a distributed system of apparatus, for example, a client/server apparatus system. In examples where an apparatus provided forms (or a method is implemented as) a distributed system, each apparatus forming a component and/or part of the system provides (or implements) one or more features which collectively implement an example of the present disclosure. In some examples, an apparatus is re-configured by an entity other than its initial manufacturer to implement an example of the present disclosure by being provided with additional software, for example by a user downloading such software, which when executed causes the apparatus to implement an example of the present disclosure (such implementation being either entirely by the apparatus or as part of a system of apparatus as mentioned hereinabove).

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavouring in the foregoing specification to draw attention to those features of examples of the present disclosure believed to be of particular importance it should be understood that the applicant claims protection in respect of any patentable feature or combination of features hereinbefore referred to and/or shown in the drawings whether or not particular emphasis has been placed thereon.

The examples of the present disclosure and the accompanying claims can be suitably combined in any manner apparent to one of ordinary skill in the art. Separate references to an “example”, “in some examples” and/or the like in the description do not necessarily refer to the same example and are also not mutually exclusive unless so stated and/or except as will be readily apparent to those skilled in the art from the description. For instance, a feature, structure, process, block, step, action, or the like described in one example may also be included in other examples, but is not necessarily included.

Each and every claim is incorporated as further disclosure into the specification and the claims are embodiment(s) of the present disclosure. Further, while the claims herein are provided as comprising specific dependencies, it is contemplated that any claims can depend from any other claims and that to the extent that any alternative embodiments can result from combining, integrating, and/or omitting features of the various claims and/or changing dependencies of claims, any such alternative embodiments and their equivalents are also within the scope of the disclosure.

1-14. (canceled)

15. The method of claim 21, further comprising:
receiving, from the RAN node, information indicative of resources allocated to the transmission of the at least one DMRS.

16. The method of claim 21, further comprising:
generating a base DMRS matrix for the UE, based at least in part on the DMRS matrix information and the DMRS submatrix information, wherein the base DMRS matrix for the UE is defined as a submatrix of the row-orthogonal DMRS matrix that corresponds to the submatrix of the row-orthogonal DMRS matrix assigned to the UE indicated in the DMRS submatrix information.

17. The method of claim 21, further comprising:
receiving, from the RAN node, information indicative of a value unique to a Radio Access Node; and
generating, based at least in part on the value, a pseudo-random diagonal matrix.

18. The method of claim 21, further comprising:
generating a DMRS matrix for the UE based, at least in part, on the base DMRS matrix for the UE and the pseudo-random diagonal matrix.

19. The method of claim 18, further comprising:
generating a UE DMRS transmission matrix for controlling the UE's transmission of the one or more DMRSs, wherein the UE DMRS transmission matrix is generated based, at least in part, on applying the DMRS matrix for the UE to a precoder and/or a power scalar.

20. The method of claim 19, further comprising:
controlling the transmission of the one or more DMRSs based at least in part on the UE DMRS transmission matrix.

21. A method comprising causing, at least in part, actions that result in:
receiving, at a User Equipment, UE, from a Radio Access Network, RAN, node, demodulation reference signal, DMRS, matrix information indicative of a row-orthogonal DMRS matrix;
receiving, at the UE from the RAN node, DMRS submatrix information indicative of a submatrix of the row-orthogonal DMRS matrix that has been assigned to the UE;
determining, at the UE, at least one DMRS based at least in part on the DMRS matrix information and the DMRS submatrix information;
transmitting, from the UE to the RAN node, the at least one DMRS.

22. (canceled)

23. An apparatus comprising:
at least one processor; and
at least one memory storing instructions that, when executed by the at least one processor, cause the apparatus at least to:
send, to one or more User Equipment, UE, demodulation reference signal, DMRS, matrix information indicative of a row-orthogonal DMRS matrix;
send, to a UE of the one or more UE, DMRS submatrix information indicative of a submatrix of the row-orthogonal DMRS matrix that has been assigned to the UE;
receive, from the UE, said at least one DMRS determined by the UE based, at least in part, on the DMRS matrix information and the DMRS submatrix information.

24. The apparatus of claim 23, wherein the DMRS matrix information comprises DMRS matrix type information indicative of a type of the row-orthogonal DMRS matrix.

25. (canceled)

26. The apparatus of claim 23, wherein the apparatus is further caused to determine a size of the row-orthogonal DMRS matrix, wherein the size of the row-orthogonal DMRS matrix is based, at least in part, on one or more selected from the group of:
a number of orthogonal DMRSs to be generated by the one or more UE, and
a number of transmitting spatial layers to be supported.

27. The apparatus of claim 23, wherein the apparatus is further caused to determine one or more selected from the group of:
a number of orthogonal DMRSs to be generated by the one or more UE, and
a number of transmitting spatial layers to be supported.

28. (canceled)

29. The apparatus of claim 23, wherein the apparatus is further caused to assign the submatrix of the row-orthogonal DMRS matrix to the UE.

30-32. (canceled)

33. The apparatus of claim 23, wherein the apparatus is further caused to:
send, to a plurality of co-schedule UE, DMRS matrix information indicative of a row-orthogonal DMRS matrix;
send, to each UE, DMRS submatrix information indicative of a submatrix of the row-orthogonal DMRS matrix that has been assigned to the respective UE;
send DMRS resource allocation information indicative of a plurality of resources allocated to the transmission of the plurality of UE's respective one or more DMRSs;
sending configuration information for configuring each UE to transmit its respective one or more DMRSs over the of plurality of allocated resources such that each UE transmits its respective one or more DMRSs over the same plurality of allocated resources;
receive, over the same plurality of allocated resources, each UE's respective one or more DMRSs.

34. A User Equipment, UE, comprising:
at least one processor; and
at least one memory storing instructions that, when executed by the at least one processor, cause the apparatus at least to:
receive, from a Radio Access Network, RAN, node, demodulation reference signal, DMRS, matrix information indicative of a row-orthogonal DMRS matrix;
receive, from the RAN node, DMRS submatrix information indicative of a submatrix of the row-orthogonal DMRS matrix that has been assigned to the UE;
determine at least one DMRS based at least in part on the DMRS matrix information and the DMRS submatrix information;
transmit, to the RAN node, the at least one DMRS.

35. The UE of claim 34, wherein the UE is further caused to:
receive, from the RAN node, information indicative of resources allocated to the transmission of the at least one DMRS.

36. The UE of claim 34, wherein the UE is further caused to:
generate a base DMRS matrix for the UE, based at least in part on the DMRS matrix information and the DMRS submatrix information, wherein the base DMRS matrix for the UE is defined as a submatrix of the row-orthogonal DMRS matrix that corresponds to the submatrix of the row-orthogonal DMRS matrix assigned to the UE indicated in the DMRS submatrix information.

37. The UE of claim 34, wherein the UE is further caused to:
receive, from the RAN node, information indicative of a value unique to a Radio Access Node; and
generate, based at least in part on the value, a pseudo-random diagonal matrix.

38. The UE of claim 37, wherein the UE is further caused to:
generate a DMRS matrix for the UE based, at least in part, on the base DMRS matrix for the UE and the pseudo-random diagonal matrix.

39. The UE of claim 38, wherein the UE is further caused to:
generate a UE DMRS transmission matrix for controlling the UE's transmission of the one or more DMRSs, wherein the UE DMRS transmission matrix is generated based, at least in part, on applying the DMRS matrix for the UE to a precoder and/or a power scalar.

40. The UE of claim 39, wherein the UE is further caused to:
control the transmission of the one or more DMRSs based at least in part on the UE DMRS transmission matrix.
